(19) United States
(12) Patent Application Publication
(10) Pub. No.: US 2013/0080471 A1
(43) Pub. Date: Mar. 28, 2013

(54) INTERACTIVE ELECTRONIC READER WITH PARENTAL CONTROL

(71) Applicants: Deborah Forte, New York, NY (US); Caroline Jill Fraser, Brooklyn, NY (US); Jody S. Nisson, Brooklyn, NY (US); Sharon Jody Lisman, Westfield, NJ (US); Jessica Sara Wollman, Brooklyn, NY (US); Seth Seigel Laddy, Fair Lawn, NJ (US); Peter Chapman, Bedford, MA (US); Mathew Bridges, Newton, MA (US); Henry Peter Surprenant, JR., Wilmington, MA (US)

(72) Inventors: Deborah Forte, New York, NY (US); Caroline Jill Fraser, Brooklyn, NY (US); Jody S. Nisson, Brooklyn, NY (US); Sharon Jody Lisman, Westfield, NJ (US); Jessica Sara Wollman, Brooklyn, NY (US); Seth Seigel Laddy, Fair Lawn, NJ (US); Peter Chapman, Bedford, MA (US); Mathew Bridges, Newton, MA (US); Henry Peter Surprenant, JR., Wilmington, MA (US)

(21) Appl. No.: 13/594,460

(22) Filed: Aug. 24, 2012

Related U.S. Application Data
(60) Provisional application No. 61/527,957, filed on Aug. 26, 2011.

(51) Int. Cl. G06F 21/62

(52) U.S. Cl. CPC G06F 21/6218
USPC 707/785

(57) ABSTRACT

An e-reader with a password protected supervisory account that controls various features and functions of the e-reader, and e-reader user profile accounts for reading users of the e-reader. The supervisory account permits the supervisor user to set up one or more e-reader user profiles that are each assigned its own customizable bookshelf for displaying the available electronic published content, such as, e-books. The electronic published content is assigned to each e-reader user profile through the supervisory account. The e-reader provides interactive content that reinforces development of reading skills and reading comprehension. The e-reader provides reading-level specific definitions and an audible pronunciation of the words. The e-reader has zooming and scrolling capabilities. The e-reader may also present suggestions and recommendations for further reading based on the aggregation of reading statistics for all readers by user profile. The e-reader tracks e-reader user information and presents the information to the password protected supervisory account. Multiple instances of the e-reader may exist and be associated with the supervisory account and e-reader user profiles.

### CROSS REFERENCE TO RELATED APPLICATIONS

The present application claims benefit to the filing date of Provisional Application No. 61/527,957, filed on Aug. 26, 2011.

### TECHNICAL FIELD OF THE INVENTION

The present invention is an interactive electronic book reader with parental or administrative control features that works in tandem with a content delivery system and/or an e-commerce website. The electronic book reader has a password protected parental or administrative level that permits access to customization and reporting features for monitoring and controlling the reader's activities while a reader user level permits access to the electronic book content with various functions that aid the reader in developing reading skills and comprehension.

### BACKGROUND

The distribution of digital content has gained importance with the proliferation of mobile computing devices. One of the growing segments of the distribution of digital content is with respect to electronic books or e-books. An e-book is typically a book-length publication in digital form, consisting of text, images, or both, and produced on, published through, and readable on computers or other electronic devices. Sometimes the equivalent of a conventional printed book, e-books may originate as a conventional printed book or can be first generated as a digital book. E-books may be read on dedicated e-readers, tablet computers, notebook computers, laptop computers, desktop computers and some mobile devices such as mobile phones.

There are several different implementations of e-readers. A dedicated e-reader is a portable electronic device that is designed primarily for the purpose of reading e-books. Dedicated e-readers are similar in form to a tablet computer. A tablet computer typically has a faster screen capable of higher refresh rates which makes them more suitable for interaction. A tablet computer will typically run an application that permits it to act as an e-reader, but generally has more flexibility in use because many such devices use touchscreens, have large amounts of memory and have the capabilities of personal computers. Mobile phones, smart phones and similar handheld devices operate similar to a tablet computer. Lastly, personal computers, such as notebooks, laptops and desktop computers, may also run an application that permits them to act as an e-reader.

There is a large variety in the display capabilities and functions of e-readers. Dedicated e-readers tend to provide simple text that is segmented into pages depending on the size of the displayed font. The pages are turned by either pressing a page advance button or swiping a touch-sensitive screen. Tablet and personal computers typically run applications that provide the e-books with the look of a traditional book, where the text is provided on what appears as two pages of an open book. Advancing the page causes the text on both pages of the open book to advance to the next two pages of the e-book. E-readers may have linked dictionaries that permit the reading user to look up words that appear in the e-book. They may also present the e-books as front cover icons on a bookshelf or provide them as a list of icons and e-book titles, so that the user simply selects a book to read.

E-books are typically distributed through numerous websites on the Internet. E-books are available through public libraries, not-for-profit institutions and for-profit companies. The availability of e-books is limited mainly by the cost of conversion to an e-book, and by limitations due to ownership and copyrights. Works no longer protected by copyright may be made publicly available and need only be converted electronic form and downloaded to the e-reader device. However, more recent works are typically protected by copyright. For this reason, companies typically use some form of digital rights management (DRM) to limit the use of digital content after sale. To implement DRM schemes, many e-readers require an account with an e-book provider. For example, the Apple Ipad tablet computer includes a built in e-reader application. E-books are distributed to the built-in e-reader through a proprietary on-line service.

Current e-readers are configured for users with established reading capabilities. These e-readers use the functionality of these computing devices to enhance the purchasing experience and reading capabilities of users who have established a competency in reading. However, dedicated e-readers and personal computers with e-reader applications have the capability of aiding those who are learning to read. These devices can provide a personalized and an interactive experience similar to that which is provided by a parent or teacher to assist with the development and reinforcement of reading skills. The devices also have the capability of providing monitoring and reporting of reading activities and evaluation of the development of reading skills.

It is with the foregoing in mind that the following, inventions are illustrated and described below.

### BRIEF DESCRIPTION OF THE DRAWINGS

FIG. 1 is a system diagram of a network within which the invention may be implemented;

FIG. 2 shows the structure of a device that may be used for implementing the invention;

FIG. 3 is a flow diagram of the initial setup of one embodiment of the present invention;

FIG. 4 is one embodiment of the initial bookshelf setup page;

FIG. 5 is one embodiment of the page for assigning books to different bookshelves;

FIG. 6 is one embodiment of the page displayed on completion of initial bookshelf setup;

FIG. 7 is one embodiment of the home page for the e-reader;

FIG. 8 is shows one implementation of the supervisor and user access to the e-reader functions depending on how accessed and the state of the Internet connection;

FIG. 9 is one embodiment of a flow diagram for assigning books to different bookshelves for e-reader user profiles;

FIG. 10 is a page showing the supervisor or parent tools section of the e-reader application;

FIG. 11 is a page showing the addition or deletion of bookshelves assigned to e-reader user profiles;

FIG. 12 is one embodiment of a page for the wish list and recommendations in the supervisor or parent tools section of the e-reader application;

FIG. 13 is one embodiment of a page for the reading reports;

FIG. 14 is one embodiment of a flow diagram for generating and displaying the reading reports of the e-reader application;

FIG. 15 is a page showing the settings section of the supervisor or parent tools section of the e-reader application;

FIG. 16 is one embodiment of the bookshelf assigned to an e-reader user profile;

FIG. 17 is one embodiment of a section of the bookshelf when the cursor is hovered over a book icon;

FIG. 18 is shows the front cover of an e-book when the e-book is opened from the bookshelf;

FIG. 19 shows a normal page layout for a user when reading a page of the e-book;

FIG. 20 shows the zoom and scroll feature;

FIG. 21 shows the next section to be read of the book when in the zoom and scroll mode;

FIG. 22 shows a picture book layout when the e-reader provides an audible read through of the e-book;

FIG. 23 is a flow diagram for the visual and audible dictionary feature;

FIG. 24 is a page showing the visual and audible dictionary feature;

FIG. 25 is a flow diagram of the interactive media for reinforcing reading comprehension and skills;

FIGS. 26, 27, 28 and 29 are examples of interactive content reinforcing media;

FIG. 30 is a flow diagram for the top ten picks feature;

FIGS. 31, 32 and 33 are pages for the picture starter feature;

FIG. 34 is a page display of the top ten lists in the Friends & Reading Group section of the e-reader application;

FIG. 35 is a page display of the Ratings & Reviews in the Friends & Reading Group section of the e-reader application;

FIG. 36 is a page display of the Friends section in the Friends & Reading Group section of the e-reader application;

FIG. 37 is a page display of the Reading Groups section in the Friends & Reading Group section of the e-reader application;

FIG. 38 is a page display of a group reading in the Reading Groups section in the Friends & Reading Group section of the e-reader application; and

FIG. 39 is a page display of a Discussion in the Reading Groups section in the Friends & Reading Group section of the e-reader application;

### DETAILED DESCRIPTION

Various embodiments now will be described more fully hereinafter with reference to the accompanying drawings, which form a part hereof, and which show, by way of illustration, specific embodiments. However, this invention may be embodied in many different forms and should not be construed as limited to the embodiments set forth herein. Rather, these embodiments are provided so that this disclosure will be thorough and complete, and will hilly convey the scope of the invention to those skilled in the art. Similarly, the page displays of the user graphical interface are merely exemplary and may take many different forms. The following detailed description is not to be taken in a limiting sense.

Throughout the specification and claims, the following terms take the meanings explicitly associated herein, unless the context clearly dictates otherwise. The phrase “in one embodiment” does not necessarily refer to the same embodiment, although it may. Furthermore, the phrase “in another embodiment” does not necessarily refer to as different embodiment, although it may. Thus, as described below, various embodiments of the invention may be readily combined without departing from the scope or spirit of the invention.

In addition, as used herein, the term “or” is an inclusive “or” operator, and is equivalent to the term “and/or,” unless the context clearly dictates otherwise. The term “based on” is not exclusive and allows for being based on additional factors not described, unless the context clearly dictates otherwise. In addition, throughout the specification, the meaning of “a,” “an,” and “the” include plural references. The meaning of “in” includes “in” and “on.”

As used herein, an “e-book” is defined as a publication in digital form, consisting of text, images, or both, typically having characters, storylines and plots, that is produced on, published through, and readable on computers or other electronic devices. Examples of e-books include picture books, leveled readers, graded readers, young adult books, texts, novels and novellas. E-books may come in many different types of formats, including for example, XPS files, XML-based files, ibooks files, AZW files, Kindle Format 8 files and so on. All of these different formats for e-book files are encompassed within the term “e-book file.” An “e-reader” is defined as a dedicated e-book reader, tablet computer, notebook computer, laptop computer, desktop computer, PDA, mobile phone or other microprocessor-driven device having a display, memory and user input device (such as a keyboard, mouse, track pad, buttons or touch-sensitive display) that runs a software application program that permits the presentation of au e-book on the display of the device. An e-reader may be used for e-books, magazines, newspapers, technical references, educational text books, foreign language books and similar written materials. As used herein, “electronic published content” is any readable content that may be displayed on an e-reader.

The e-reader has a password protected supervisor account that controls various features and functions of the e-reader. A supervisor is typically a teacher, parent or a person in the role of monitoring, enabling or facilitating the reading of an e-reader user. An e-reader user is typically a student, child, employee or other person that is learning through reading on the e-reader. The supervisor account sets up one or more e-reader user profiles for reading users of the e-reader. A personalized bookshelf is created for each e-reader user profile. A “bookshelf” is defined as a page display on the e-reader where a summary of electronic content is displayed by front cover icons, typically in a replica of a real life bookshelf. The bookshelf may be personalized on the page with information such as the user's name. The supervisor account permits the supervisor to assign e-books to the various bookshelves. The e-reader users accessing the e-reader through the e-reader user profiles typically do not have access to the features and functions of the supervisory account. Once e-books are assigned, the e-books are placed on the bookshelf associated with the e-reader user profile and become accessible by the e-reader user having that e-reader user profile.

The e-reader uses the interactive capabilities of computing devices by providing interactive content such as games, puzzles and quizzes that relate directly to the content of the e-book being displayed to the e-reader user. As used herein, “interactive content-reinforcing media” means games, puzzles, quizzes and any other activity requiring input from the user that directly relates to content of the plots, characters, actions or story line, of the e-book content occurring on or prior to an e-book page linked to the media and that provides aid in testing and reinforcing reading skills and comprehension. Interactive content-reinforcing media may include story interactions as described herein. The e-reader provides reading-level specific definition for words and an audible pronunciation of the word. The e-reader may have zooming and scrolling capabilities to allow the magnification of the pages of e-book for continuous reading. The e-reader may also present suggestions and recommendations for further reading based on designation of e-books as “favorites” through use of drag and drop stickers, or the aggregation of reading statistics for all readers by user profile. The e-reader may also present content that has branching story lines, where the direction of the story is determined by decisions and information provided by the user at certain points within the story.

The e-reader tracks e-reader user information. This information may then be presented in e-reader user reports to the supervisor user on accessing the supervisor account so that the supervisor user may monitor each e-reader user's usage. The available information and statistics would be things such as the minutes or hours spent reading each day or week, the number of pages read, words read, the speed of reading, the number and/or types of words looked up in the dictionary, and the number and results from accessing interactive content-reinforcing material. The information may contain any information or statistics related to reading, comprehension, usage, testing, or learning.

Multiple instances of the e-reader may exist and be associated with the supervisory account and e-reader user profiles. The e-reader software application may be installed, for example, on a tablet computer and desktop computer. On accessing a central server, the current instance of the e-reader may be updated with new e-books, current reading locations and similar information that may have been generated or accessed through other instances of the e-reader. The information downloaded from the central server may also include recommendations for e-books being read by individuals with similar profiles or reading levels as that of the e-reader users.

The e-reader may enable social networking activities. E-reader users may connect with friends, form reading groups, engage in discussions about e-books they are reading and may engage in shared reading sessions.

Environment for Implementing the Invention

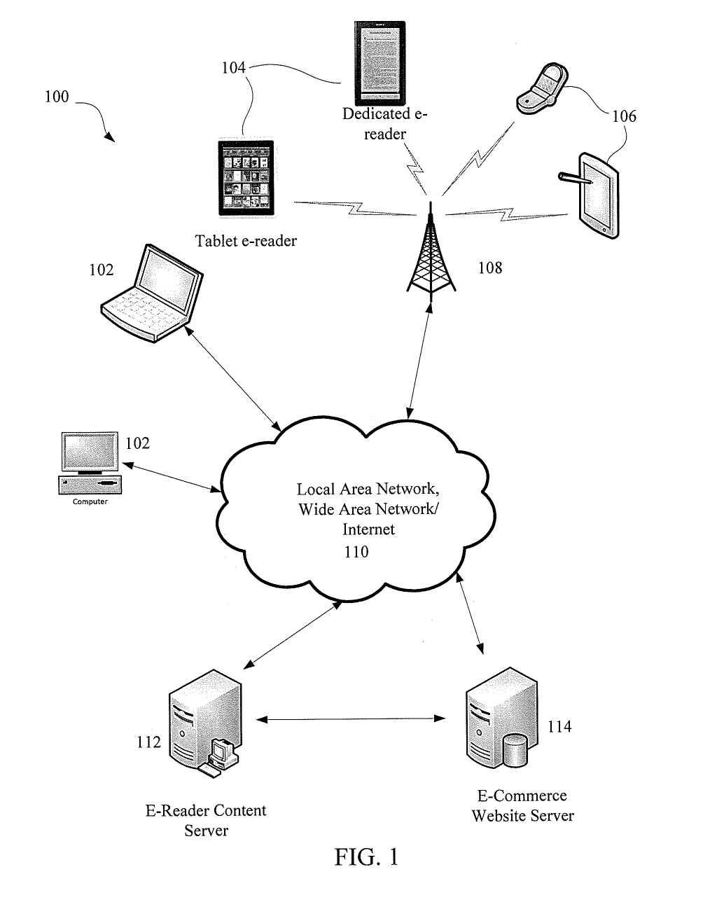

Network 100 is shown in FIG. 1. Not all of the components are required for any given implementation of the invention, and variations in the arrangement and types of components may be made without departing from the scope of the invention. As shown in FIG. 1, e-readers 102, 104 and 106 can consist of dedicated e-readers, tablet e-readers, laptop computers, desktop computers and any other device that may be capable of establishing a communication link with Internet/Local Area Network/Wide Area Network 110 through a wired or wireless medium and runs an application program enabling the device to operate as an e-reader. E-readers may be linked to other Wide Area Networks and/or Local Area Networks. Wireless e-readers 104, 106 are connected to Internet/Local Area Network/Wide Area Network 110 through wireless network 108. The e-readers may be capable of identifying their location to other devices within the various networks. For example, cellular phones can identify themselves through Mobile Identification Numbers, Electronic Serial Numbers or mobile phone numbers. Computer devices can identify themselves through network addresses or other device identifiers. The identifier information may be included messages or information sent to other devices within the various networks so that communications can take place through the network between the devices. Such communication can take place through known communication methods such as Short Messaging Service (SMS), Multimedia Message Service (MMS), Instant Messaging, (IM). Internet Relay Chat (IRC), Jabber or the like. Any suitable protocol or method of communication can be used to implement the current invention.

The e-readers include application programs that send and receive web-pages, web-based messages, and data packets having content for updating e-books and related content on the e-reader. The e-readers may have operating systems that enable the application programs.

The various networks may also include network devices that provide e-books, manage accounts and provide related content to users such as e-reader content server 112 and e-commerce website server 114. These devices are capable of sending and receiving text, e-books, graphics, illustrations, photographs, web pages, multimedia information, and the like. These devices provide a website for the presentation, selection and purchase of e-books for use on e-readers. These devices may provide the capability of downloading to e-reader devices, including the downloading of the e-reader application software.

Local area network/wide area network/Internet 110 may couple e-reader content server 112 to other computing devices including e-readers 102, wireless e-readers 104, 106 and e-commerce website server 114. E-reader content server 112 may include any type of computing device capable of networking with Local area network/wide area network/Internet 110 and enabled to communicate with various other content servers. E-reader content server 112 is configured to generate an e-book supervisor account and associated e-reader user profiles that can be accessed by e-readers 102, 104 and 106. E-reader content server 112 can draw e-book content from e-commerce website server 114 in implementing this invention. Local area network/wide area network/Internet 110 can use any form of computer readable media for communicating with the various electronic devices. The connections between the electronic devices can be through twisted pair, coax, fiber optics, satellite, carrier waves or any other commonly known medium. The communications can take place through routers and other networking equipment in a conventional manner. Further, the communications can have dynamic architectures and use any of a number of known protocols for communication.

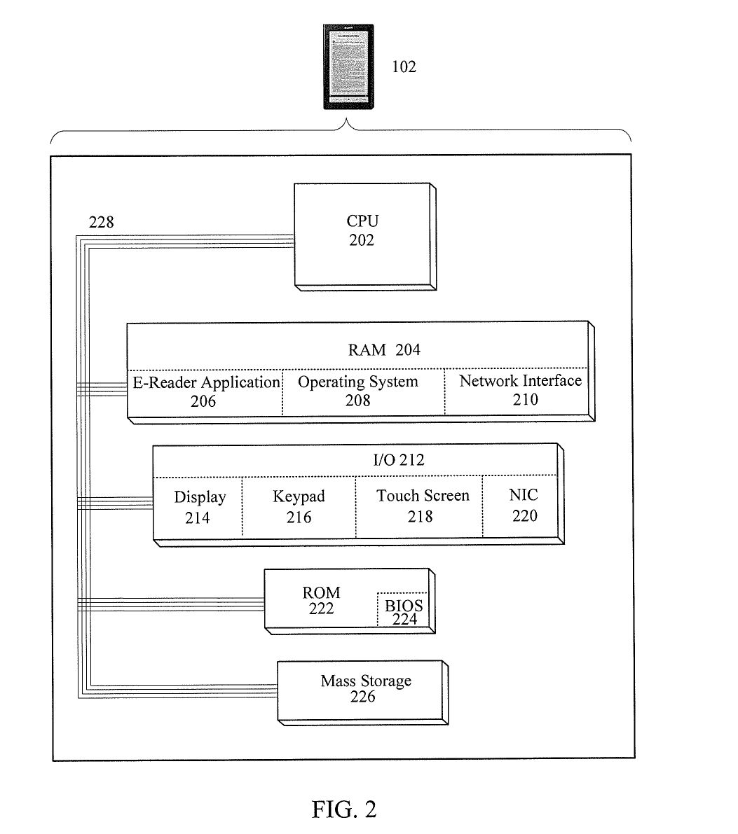

FIG. 2 shows one embodiment of an e-reader. The e-reader includes central processing unit 202, RAM 204, input/output interface 212, ROM 222, and mass storage device 226. The various components are interconnected by bus 228. RAM 204 may contain various operating programs such as e-reader application 206 operating system 208 and network interface 210. The network device communicates through Input/Output device 212. Input/Output device 212 can constitute a number of separate devices. For instance, it may contain a display 214, keypad 216, touch screen 218, network interface card 220, peripheral controllers and the like. ROM 222 may include a Basic Input/Output System (BIOS) 224 for controlling the low level operation of the e-reader.

The network device of FIG. 2 may also contain mass storage 226 which can be hard drives, optical drives, memory chips or similar devices for storing large quantities of data in non-volatile memory. Mass storage 226 may also store other program code and data. One or more e-reader applications 206 may be stored in mass storage 226 and then run within the environment of operating system 208.

Various aspects of the invention can be implemented in several different ways. For example, the invention can be implemented through a traditional client server arrangement or a peer-to-peer network architecture. The application program can be implemented in client devices network-devices or any combination of various devices.

The e-reader of the present invention is a proprietary application software program that may be downloaded and installed on computers and handheld devices. The e-reader application software installed in e-readers 102, 104, 106 works in tandem with e-reader content server 112 and e-commerce website server 114. The application may be run within any number of platforms or operating systems such as Microsoft Windows, Mac OS, Android, Linux or the like.

Initial Setup

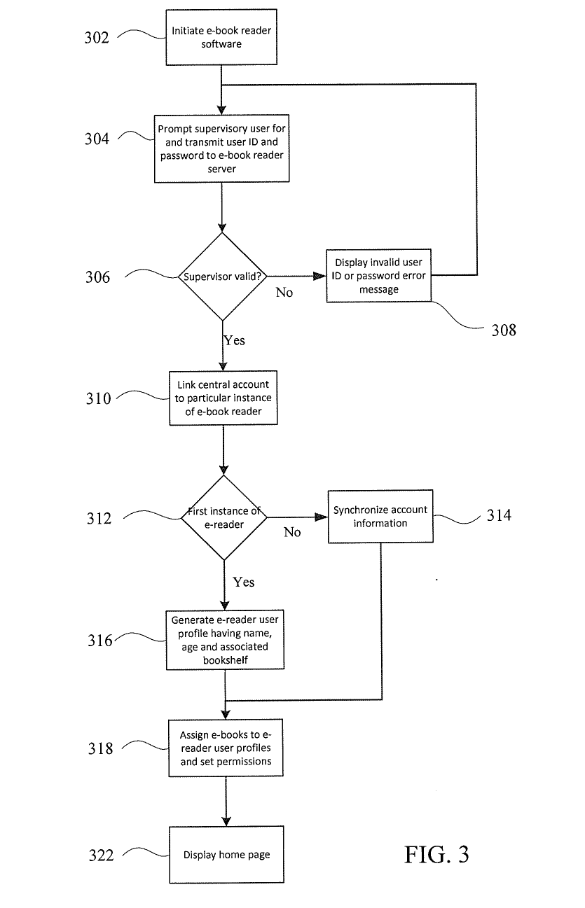

The initial setup of the e-reader software is shown in the flow diagram of FIG. 3. The user may first be required to download the e-reader application software from, for example, e-reader content server 112. On installation and launching of the e-reader for the first time as shown in block 302, the e-reader connects via local area network/wide area network/Internet 110 so that the e-reader may communicate with e-reader content server 112. If there is no connection, the user will be prompted to connect to the Internet and to try again. Next, the user is prompted for a user ID and password in block 304 which is transmitted to e-reader content server 112. The user ID and password correlates to a pre-existing account within an e-commerce website that is run on e-commerce website server 114. If the user does not have a pre-existing account, then the user can elect to create an account.

The user ID and password are validated in decision block 306. If invalid, an error message is returned in block 308 and the user is re-prompted to enter their login information. Once the user ID and password are validated the software is linked with the pre-existing e-commerce website account until the de-registration of that particular instance of the e-reader. At this point, a unique device ID may be generated for the device. The unique ID will be used to identify the device in all future interactions with e-book content server 112 avoiding the need to use authentication every time the e-reader connects. For each e-reader account, e-reader content server 112 maintains and tracks information about the e-reader devices assigned to that account. The information includes the unique device ID, the name of the device, whether the device is active or de-registered and the timestamp of the last time the e-reader successfully completed synchronization with e-reader content server 112. There may be a limit on the number of e-reader devices capable of being registered. In one embodiment, the maximum number of devices on which the e-reader may be installed is five. If the e-reader application is already installed on five devices, the user will not able to install it on the current device and a message is displayed to that effect.

If the e-reader account is pre-existing and the current e-reader device is an additional e-reader device on the account, then e-reader content server 112 will synchronize the e-reader with the server information as shown in block 314. If there are no other instances of the e-reader software, the software launches a first-time setup wizard.

On registration of a device for the first time, a number of free books may automatically be assigned to the account. These books are displayed immediately in the supervisor/parent tools section and can be assigned to any bookshelf. They are not, however, downloaded to the device until a user decides to open and read them. The selection of books may include samples, public domain books, or regular for-pay books and can be easily changed over time.

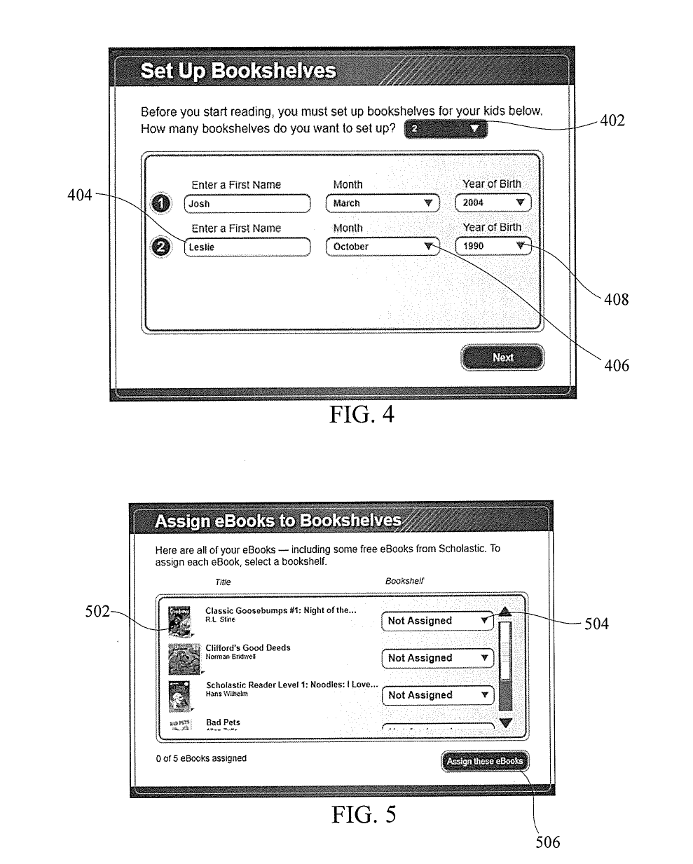

After registration of the device, the first-time setup wizard defines the initial set of bookshelves and assignment of any books already in the possession of the e-commerce account. The first screen of the wizard prompts for the creation of any number of bookshelves as shown in block 316 of FIG. 3. These bookshelves are e-reader user profiles for each e-reader user. In one embodiment, the supervisor user would be a parent, and the bookshelves or e-reader user profiles would be each child of the parent. In another embodiment the supervisor would be a teacher and each of the bookshelves would be the students in the teacher's class. This is not limited and may include any other supervisor/teacher to student/subordinate relationship. An entry screen for this is shown in FIG. 4. Pull down menu 402 allows the user to specify any number of bookshelves, for example, from one to ten with a default value of two. Each time the user changes this pull down, entry fields appear for the number of specified bookshelves. Three entry fields can fit on screen at a time; if the user select more than this, a scroll bar appears. In one embodiment, the user enters the reader's name in field 404 and birth date information as indicated in pull down menus 406 and 408. The user then clicks “Next” to advance to the next frame. All of the bookshelves specified are created and any bookshelves for which the “first name” field was left blank are not created.

Next, the user will be prompted to assign e-books to bookshelves in block 318 of FIG. 3. An example of the screen is shown in FIG. 5. All of the eBooks owned by the account appear on this screen, appealing as book icons 502 along with a book title and author. This screen may also show other book details such as the type of book, length, purchase date and other information. This may include at least the set of free e-books that were provided on registration of a device for the first time to the account. It also includes any e-books that were purchased prior to downloading and installing the software.

Pull down menu 504 next to each book includes all of the bookshelves that were defined in the previous step, as well as those e-books “Not Assigned”. A counter in the bottom left keeps track of how many books have been assigned out of the total number owned. This step is completed by clicking button 506 labeled “Assign these books,” These e-books are then assigned to these e-reader user profiles as shown in block 318 of FIG. 3.

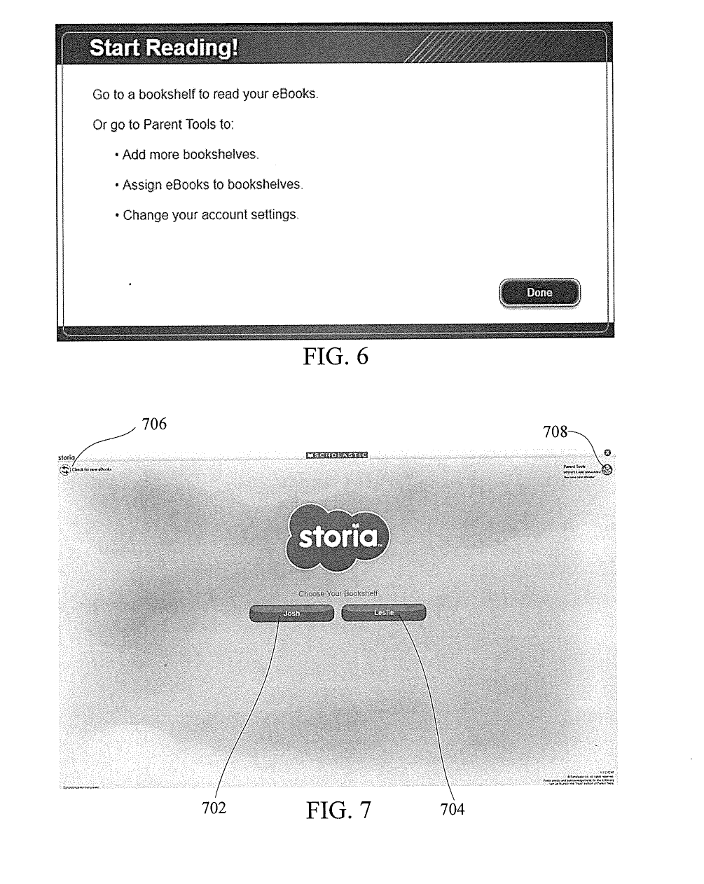

The next screen of the wizard may offer the option of automatically assigning new e-books in the future. This screen appears only on creation of a single bookshelf. This may be considered the single e-reader user family option. When selected, this causes e-book purchased to go directly to the e-reader user without requiring assignment by the supervisor/parent. A final wizard screen indicates that the process is finished as shown in FIG. 6, and then the home page is displayed as shown in block 322 of FIG. 3.

A sample of the home page is shown in FIG. 7. The home page shows a list of bookshelves set for the account that may be accessed by pressing virtual buttons 702, 704. The user can also check e-reader content server 112 for any newly purchased e-books through link 706 or access the supervisory or parent account through link 708.

Bookshelf and E-book Management

E-reader content server 112 maintains a bookshelf that lists all of the e-books owned by the e-reader user account. The bookshelf on E-reader content server 112 will maintain the list of all e-book assets acquired through the e-commerce website by the supervisor. In particular it may include sample chapters, purchased e-books and free public domain e-books that were requested on the e-book website, as well as e-book and samples that were automatically added to the user's bookshelf at the time the account was created and rewards assigned to e-reader users.

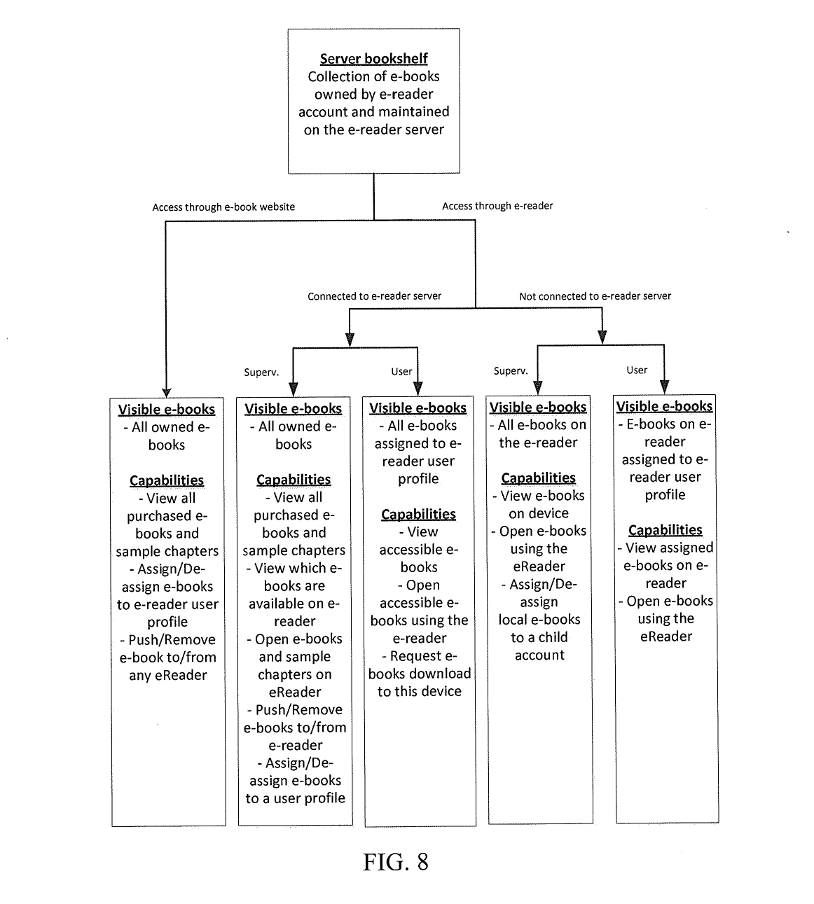

The diagram in FIG. 8 illustrates the various views of the server bookshelf that supervisors and the corresponding e-reader user profiles can access and manipulate. These different possible views of the server bookshelf collection depends how the bookshelf is being accessed. This can be either from the e-reader or directly through the e-reader website. When the bookshelf is being accessed from the e-reader, the view and the capabilities will change depending on whether the device is operating connected or disconnected from e-reader content server 112, whether the bookshelf is being accessed by the supervisor using account access codes or from the e-reader user profile associated with the e-reader account, and how the supervisor is accessing the bookshelf from the e-reader, either from the supervisor tools for administration purposes, or from the supervisor bookshelf which provides a more appealing user experience for e-book browsing and reading.

The following additional details are provided for each possible bookshelf view resulting from the possible combinations of the above factors. E-books may be viewed by accessing e-reader content server 112 via a web browser. This feature may only be available accessing for supervisor accounts using password access. The server bookshelf view is provided through a widget served directly from e-reader content server 112. The bookshelf widget may be presented within the e-book web page. When the supervisor navigates to the server bookshelf; they may not have to re-authenticate with e-reader content server 112. The authentication may be handled automatically behind the scenes.

When a supervisor accesses the server bookshelf by using a web browser, e-commerce website server 114 receives the request to view the server bookshelf and returns the server bookshelf page frame containing calls to e-reader content server widgets along with request for user ID and password. The user's browser passes the request for widgets and user ID information to e-reader content server 112. E-reader content server 112 validates the user ID and password and returns the widgets to the user's browser, and also sets up its own session or equivalent with the user's browser. The request is then fulfilled by e-reader content server 112.

The server bookshelf widget may provide the following capabilities:
View the e-books and sample chapters contained in the server bookshelf. In this instance, users may not be able to open or access the e-books and sample chapters from the server bookshelf.
View which e-books and sample chapters are assigned to each profile.
Assign or de-assign e-books and sample chapters to/from any profile. In one embodiment, e-books may be assigned to no more than one profile at a time.
Delete sample chapters and e-books from the server bookshelf. If a user deletes a paid-for e-book from the bookshelf, the bookshelf presents a warning message that the deletion is permanent and the user will not be able to access the e-book again unless the book is purchased again. This is equivalent to disposing of a paper book.
Sort the bookshelf by most recently purchased, alphabetical by author, or alphabetical by title.
Filter the titles in the server bookshelf by sample chapter or by complete e-books.
Change the preference for automated assignments of e-books when a new e-book is purchased.
Change the preference about the tracking and storing of reading statistics for the profiles.

When the supervisor accesses the bookshelf through the e-reader when the e-reader is connected to the Internet, the e-reader provides two ways for supervisors to interact with the bookshelf.

First, a supervisor may define an e-reader user profile for themselves on the e-reader, which the supervisor can use to browse and read e-books just as with any other e-reader user profile. This view is intended for reading and not for bookshelf administration, may be password protected, is accessible via the e-reader display and is similar in every aspect to the e-reader user profile bookshelves. Only the e-books and sample chapters that the supervisors have assigned to themselves will be accessible in this view. If supervisors have opted for automated assignment of all e-books to all e-reader user profile bookshelves, all e-books will automatically be assigned to the supervisor bookshelf too. This view also displays e-books that are either available or not available on the local device. E-books and sample chapters that are not stored on the local device appear as grayed out and the user can request them for download. It provides users with the ability to manually arrange, sort, or filter e-books in the virtual shelves as documented in the e-reader design document. These settings are local to each e-reader device and are not synchronized. The view also provides supervisors the ability to bookmark, annotate, highlight, and mark e-books as favorites just as any e-reader user profile can do.

Second, a supervisor may access the server bookshelf from the e-reader via the supervisor tools to assign e-books to e-reader user profile accounts and perform other administrative functions. This administrative access is password protected and is intended for bookshelf administration. This method of access permits sorting and filtering of e-books. The supervisor is permitted to view which e-books are available on the local device, with e-books shown on the e-reader but not yet downloaded being grayed out. The supervisor is allowed to request the download of an e-book to the local e-reader. Further, a supervisor can delete the local copy of the e-book file, without removing the e-book from the bookshelf, assign/un-assign e-books to e-reader user profile bookshelves or their own, and allows the supervisor to permanently delete an e-book from the server bookshelf. The supervisors can also create, change, or remove e-reader user profile bookshelves (this requires the e-reader to be connected), change the bookshelf settings for the e-reader user profile bookshelves, change the collected reading statistics setting and change the automated assignment of e-books to e-reader user profiles.

Similar to the previous case, there may be two ways of accessing the bookshelf when a supervisor uses the e-reader but the e-reader is not connected to e-reader content server 112. First, the supervisor may access the e-reader bookshelf to browse and read e-books using an e-reader user profile. This view is meant for supervisor reading and not for bookshelf administration, has the option to be password protected, is accessible via the e-reader main screen and is similar in every aspect to the e-reader user profile bookshelves. Only the e-books and sample chapters that the supervisors have assigned to themselves and are locally available on the device will be visible in this view. This view provides users with the ability to sort, or filter e-books in the virtual e-reader bookshelf. These settings are local to each e-reader device and are not synchronized. When the e-reader is in 9 disconnected mode the user will still be allowed to move and re-order the local e-books in the shelf. Once the user reconnects with e-reader content server 112 these changes will be reflected in the complete bookshelf that includes also the ghosted books. This view also provides supervisors the ability to bookmark, annotate, highlight, and mark e-books as favorites just as can be done by an e-reader user profile.

Second, the supervisor may access the bookshelf view via, the supervisor tools section of the e-reader application. This is password protected. This view is intended for bookshelves administration. E-books can be sorted and filtered. This view allows the supervisor to view which e-books are available on the local device, delete a local copy of a book, and to assign/un-assign these local e-books to e-reader user profile bookshelves or their own.

The e-reader user profile may view the bookshelf when the e-reader is connected to e-reader content server 112. This view allows e-reader user's profiles to access the bookshelf to read e-books. This view has the option to be password protected. E-reader user profiles' passwords may be stored locally on the e-reader and not validated against the records of e-reader content server 112. E-reader user profile's passwords are synchronized among e-reader devices using e-reader content server 112. This view is accessible via the e-reader main screen, only displays e-books that the supervisor has assigned to the e-reader user profile, and displays e-books that are either available or not available on the local device. E-books and sample chapters that are not stored on the local device appear as grayed out and the user can request them for download. This view also provides the e-reader user profile with the ability to manually arrange, sort, or filter e-books in the virtual shelves. These settings may be local to each e-reader device and are not synchronized.

The e-reader user profile may view the bookshelf when the e-reader is disconnected from e-reader content server 112. This view allows the e-reader user profile to access the bookshelf to read e-books when the device cannot reach e-reader content server 112. This view has the option to be password protected. In one embodiment e-reader user profile passwords may be locally stored on the e-reader and not validated against e-reader content server 112. E-reader user profile passwords are synchronized among e-reader devices using e-reader content server 112. This view is accessible via the e-reader main screen, only presents e-books that the supervisor has assigned to the e-reader user profiles and are local to the e-reader device, and provides users with the ability to sort or filter e-books in the virtual shelves. These settings are local to each e-reader device and are not synchronized. When the e-reader is in the disconnected mode the user will still be allowed to move and re-order the local e-books in the shelf. Once the user is connected to the server again these changes will be reflected in the complete bookshelf that also includes the ghosted books.

New e-reader accounts and corresponding bookshelves are created in e-reader content server 112 whenever a user becomes known to the e-reader content server for the first time. This may happen when a user requests a sample chapter for the first time, purchases an e-book for the first time or installs an e-reader for the first time.

With the new account, the server bookshelf for that account is also created. The bookshelf will be automatically populated with to selection of free e-books and sample chapters. The supervisor can then assign these e-books to any e-reader user profile.

The sample e-books will behave differently than any other e-book in one respect—the sample e-books will not download automatically to the e-reader regardless of the “space saver” settings on the device itself. Sample e-books will always be grayed out at the beginning and it will be up to the supervisor or the e-book user profile to request the download of the e-book to the device.

E-reader content server 112 will preserve a list of e-books that have to be added automatically to any new bookshelf. The list is provided by e-reader content server 112 or e-commerce website and should contain an indication of the thirteen digit International Standard Book Number of the e-book to be offered and the indication if the entire e-book or just the sample chapter should be provided. This list can be updated over time to always provide an up-to-date sample selection for new users. Once e-books are transferred to the user's bookshelf they will not change over time even if the list of free books changes.

Supervisors can assign e-books to e-reader user profiles once the bookshelves are created. This can be done either from the server bookshelf or from the supervisor tools in the e-reader. This function is supervisor password protected both on the server bookshelf and on the e-reader.

A setting is available both on the server bookshelf and in the e-reader supervisor tools section to control whether e-books and sample chapters are assigned automatically to no more than one profile when acquired by the user on e-reader content server 112 or e-commerce website. If the setting contains a profile name, any e-book/sample chapter purchased or acquired after the value is set will automatically be assigned to that profile. If the field is empty e-books and sample chapters will not be assigned to any profile when acquired. Changes to the field will have no retroactive effect on e-books that are already in the user bookshelf. Requests to enable automated assignment for a profile different that the one to which is currently assigned will result in a switch between the two profiles. This setting is shared by all the devices.

In one embodiment, the same e-book cannot be present in more than one profile bookshelf under the same user account. E-books can be unassigned and reassigned between profiles under the same account without limitation of time and frequency as long as the one-profile per e-book rule is enforced.

If an e-book is removed from one of the profile bookshelves, the following profile elements—bookmarks, highlights, notes, favorite settings, ratings and reviews—will be preserved. If the e-book is assigned again to that same profile/bookshelf at a later time, the e-reader will restore all of the bookmarks, highlights, notes, favorite settings, ratings and reviews that the user had previously created. When the book is not assigned to that profile, the bookmarks, highlights, etc. will not be accessible to the e-reader user.

The requirement of one-profile per e-book is only related to purchased e-books and does not strictly apply to sample chapter and public domain e-books. The requirement is extended to all e-books to avoid confusing the user with too many differences in behavior. This behavior may be modified. The ownership of multiple e-book licenses will allow the simultaneous assignment of the same e-book to multiple profiles, e.g., if the user owns licenses of the same e-book then the e-book can be present in two profile/bookshelves simultaneously.

Even if the e-books are not assigned to any of the e-reader user profiles or the supervisor, they will be downloaded to the e-reader anyway after they are acquired. This way they become immediately available after they are assigned to any of the bookshelves.

Users have the option within the account settings to enable the space saver mode. This setting is meant to reduce storage utilization by e-book files on devices with limited amount of storage, such as mobile devices. Space saver is a device specific setting and disables the automated download of the e-book files when the e-books are loaded in the e-reader device bookshelf. Even if the e-book file is not downloaded, the e-book will still appear grayed out in the supervisor bookshelf on the device and on the bookshelves of the e-reader user profile the e-book has been assigned to.

Space saver mode can only be enabled or disabled from each local device and only influences that device. It cannot be controlled from the server bookshelf and e-books will never appear grayed out in the server bookshelf, even if they are not downloaded to any device. The default setting for space saver mode is off (i.e., e-book files are downloaded to the device). If space saver mode was previously on and is turned off, it will only influence the e-books and sample chapters that will be added to the server bookshelf from that point on. E-books that were not transferred to the e-reader while space saver mode was on will have to be requested manually.

Supervisor users have the ability to delete the e-book files from the e-reader to save storage space. Files can be deleted from the supervisor view of the bookshelf under supervisor tools. E-reader user profiles may not have this possibility.

When the e-book file is deleted from the device, the e-book will be displayed as grayed out in the bookshelf. A user can request the download of the e-book to the device again and be able to fully access it. Deleting the e-book file will not result in the removal of users' bookmarks, highlights, and annotations from the device. If an e-reader device is set up to download e-book files automatically (space saver option set to OFF) and an e-book file is deleted by the user, that e-book will not be downloaded again automatically (it will remain grayed out until the user manually requests it again. If an e-book file is removed from one e-reader device, this has no influence on other devices for the same supervisor. The presence of e-book files un a device is a local setting that is not replicated across devices using synchronization.

Supervisor users have the ability to permanently remove e-books and sample chapters from the server bookshelf (and therefore from any device). This feature is available both from the server bookshelf and from the e-reader devices (under supervisor tools). Once an e-book is removed from the server bookshelf the action is propagated to all devices through synchronization.

If a supervisor attempts to delete an e-book, the system will prompt the user that the change is permanent, if the item being deleted is a sample chapter or a free book it will have to be requested for download again from e-reader content server 112 or e-commerce website. If the item being deleted is a paid-for e-book, deleting it from the server bookshelf will be equivalent throwing out the book, and the e-book will have to be purchased again to be accessed by the user.

If an e-book is deleted from the server bookshelf, all bookmarks, annotations, and highlights for all users under the supervisor account will also be deleted from all the associated e-reader devices and from e-reader content server 112.

Synchronizing

Each time that a user launches the e-reader software, the device attempts to connect to the server to perform synchronization. If the device is not connected to the Internet, this step is skipped. The synchronizing process does the following:

1) Checks whether there have been any updates to the software. Some updates may be downloaded automatically, in which case the update is downloaded immediately at this step.

2) Checks whether there are version updates to any of the individual books currently on the device, and if so, downloads and installs any updates.

3) Checks whether there are updates to any of the supervisor settings while working on another device (e.g., created new bookshelves, changed supervisor controls, etc.), and if so, imports those settings.

4) Checks whether there are updates to versions of any of the existing books (e.g., notes, highlights, favorites status, etc.) while working on another device, and if so, imports these updates.

5) Checks whether there are any purchased e-books that are not yet on the device. If the space saver setting is turned oil, these e-books are downloaded immediately, including information about bookshelves to which they have been assigned.

In one embodiment, these updates are mandatory. Updates 1 through 4 may happen before the user can start using the e-reader. While these are happening, text describes what is happening and a progress bar shows the status of each update.

After update 4 is complete, the user proceeds to the sign-in screen. More specifically, when an e-reader device is operating in a connected mode, the device will attempt to synchronize with e-reader content server 112 at e-reader startup and every time the user clicks on the “Check for New Books” button 706. The device may also attempt to synchronize when a new e-reader user profile is created or removed, when the e-reader application is closing, or when an e-book is assigned. This synchronization may be unidirectional or bidirectional, and usually is initiated by the client. As part of the synchronization operation the e-reader device checks to see if there are updates on the server bookshelf. The e-reader will check whether there is new server bookshelf content for example, new e-books, re-assignment of books among e-reader user profiles, newer versions of available e-books that are already part of the bookshelf and whether any e-book has been added to (or removed from) the favorite's list.

During bookshelf synchronization, the e-reader requests the most recent list of e-books from the server bookshelf. The list is returned to the e-reader. For each e-book, the list includes its ISBN, indicator if the e-book is a sample chapter, free e-book (non-DRM protected), or a DRM protected e-book. If both the e-book and the corresponding sample chapter are present in the server bookshelf, two records will be used for synchronization. This is because the assignments to users may be different between the complete e-book and the sample chapter. The list may also include the version number for that e-book, and assignments to the e-reader user profiles whether the book is or is not a favorite for the e-reader user profiles. The information will be sent for the supervisor and all the e-reader user profiles that are part of that supervisor account, not just for the person using the e-reader at that moment. During synchronization, the e-reader will compare the downloaded list with the local bookshelf if an e-book or sample chapter is part of the list but is not present in the local bookshelf, the e-reader will perform a second API call to obtain from the server the key metadata associated with that e-book. The call should include the ISBN for the e-book and whether the request is for the complete e-book or for the sample chapter. The metadata provided in response may include the author, title, book type (picture book, level reader, chapter book, or young adult), URLs to download the cover images, URL(s) to download the e-book file(s) and mapping between the files and the screen resolutions supported and file size(s) for the e-book file(s).

If the e-book or sample chapter is not present in the list but is in the local device bookshelf then the book was deleted by the supervisor from the server bookshelf (either through the server bookshelf or from another e-reader) and the change has to be reflected on the local device. The e-reader will proceed to eliminate the e-book (or the sample chapter) from the local bookshelf and from any user bookshelf and delete the e-book files from the device.

If the same ISBN entry appears both on the server side list and the local bookshelf, the synchronization application will still have to check if the item is the same (e-book or sample chapter). The server bookshelf may contain just the sample chapter, the e-book, or both. The local bookshelf will request the metadata from the server and obtain all the assets that are needed to match the server bookshelf to the local bookshelf (i.e., if the e-reader device only has the sample, the complete e-book metadata has to be requested).

Any cover image that is needed to populate the e-reader bookshelf with book images will be requested by e-reader content server 112 using the URLs provided with the metadata. After the server bookshelf and the local bookshelf have been fully synchronized, the e-reader device will proceed to request any e-book files that are needed. This will depend on the “space saver” setting for that e-reader device. If the space saver setting is turned on, e-books will only be downloaded when the user requests them.

The e-reader may use the file size of the e-book file metadata information to decide if there is enough storage space on the local device to download the e-book file. If the space is not sufficient a message will be presented, the e-book file will not be downloaded and the e-book will appear ghosted in the e-reader bookshelf.

Multiple URLs may be present for the e-book files, which indicates that more than one version is present for the same e-book (typically a picture book). The device will request the proper version based on its local hardware characteristics. If the device determines that that e-book cannot be displayed on that device because no e-book file version matches the display capabilities of the device, then the display will prevent the e-book from being accessible or downloaded onto that device. A proper message will be displayed for the user that tries to access an e-book not suitable for that hardware.

When a user's device is not connected the Internet, the user's device cannot communicate with e-reader content server 112. The e-reader will display a visual cue on the screen indicating that the device is not connected to the Internet. On e-reader startup and when the user clicks on the “Check for New e-Books” button, a message will also warn the user that the server bookshelf is not accessible, and newly requested e-books or sample chapters are not accessible until the user is connected again to e-reader content server 112. Accordingly, users will not see any notes or changes that were made while working on another device.

When a user's device is not connected to the Internet, users can still utilize the device as normal and can read all books that have already been downloaded. Books that have not yet been downloaded will not be visible to the user.

Enhanced e-books will be identified in the bookshelf views by a specific logo. The logo will be superimposed automatically on the cover page by the e-reader and by the Web Server in the Supervisor Tools page. The fact that an e-book is an enhanced e-book is transferred to the e-reader with the e-book metadata.

The override rules between e-books and the corresponding sample chapters are the following: If a user requests a sample chapter and then purchases an e-book, the fall e-book will replace the sample chapter in the bookshelf views. The sample chapter file will be automatically deleted from the e-reader device when it is replaced by the full e-book. If a user purchases and downloads the complete e-book and then requests a sample chapter, the two will coexist in the bookshelf as separate entities. Each one will have its own cover image and place in the bookshelf representation. A complete e-book and its sample chapter version share the same ISBN number. The unique identifier for an item in the bookshelf is given by the combination of the ISBN and the attribute that identifies the book as a complete e-book, sample chapter, or a free e-book (free e-books do not have sample chapters).

If both the e-book and the sample chapter are in the server bookshelf, two separate records will be present. Both records will have the same ISBN and will carry separate indicators on whether the e-books are DRM protected, sample chapters, or non DRM protected.

Cover page representations for e-books and sample chapters are different in that a sample chapter has a visual cue identifying it. The visual cue identifying a sample chapter may be embedded in the cover jpeg image or may be superimposed dynamically by the e-reader at presentation time.

The software may also synch on the closing of the e-reader. In this case, local updates (book assignments, annotations, etc.) are also sent upstream, meaning that any changes made to the bookshelf settings, as well as any notes, highlights, or bookmarks for individual books, are uploaded to the server.

The following tables list the inhumation elements that need to be synchronized for each supervisor account and e-reader user profile. The elements can be combined into one information group so that every time any of the information elements within the group changes (e.g., Bookshelf style), the entire group as a whole will be synchronized between the e-reader and e-reader content server 112.

Account and Profile—Account information and e-reader user profile information may need to be synchronized in both directions—i.e., from e-reader content server 112 to the e-reader, and vice versa.

| Field name | Description |
|---|---|
| Unique Account ID | This is the e-commerce website ID. |
| Store Reading | This logical value controls whether reading statistics are stored |
| Statistics | for any profile under the user account. |
| Automatically | This is the unique profile that e-books are assigned to automatically |
| assign profile | when purchased or requested. NULL value turns automatic |
| | assignment off. |
| Profile ID | Unique user profile ID. |
| Screen name | This is only significant for e-reader user profiles. The name chosen |
| | by the supervisor and used to identify the e-reader user profile on the |
| | device. |
| Password | The optional password for the e-reader user profile. A NULL |
| | string means that the e-reader user profile has no password. |
| First name | This is only significant for e-reader user profiles. For example, this |
| | may be the first name of the e-reader user, e.g., a child or student. |
| Birthday | This is only significant for e-reader user profiles. For example, this |
| | could be the birth date of the e-reader user. |
| Bookshelf style | The shell used for presentation of the bookshelf, whether |
| | young, older, or supervisor. |
| Enable | This is only significant for e-reader user profiles. Set by the |
| story | supervisor. Controls whether the interactive content-reinforcing |
| interactions | media is displayed to the e-reader user profile. |
| E-reader user | This is only significant for e-reader user profiles. Set by the |
| allowed to set | supervisor. |
| password | |

Bookshelves—This information group contains all of the information elements that will be exchanged when the bookshelf content is synchronized from e-reader content server 112 to the e-reader. The bookshelf synchronization will contain a set of the elements in the table below for each of the e-books and sample chapters contained in the bookshelf.

The same information elements/group can be synchronized from the e-reader to e-reader content server 112 when e-book assignments or favorite settings are changed on one of the e-readers. In this case only the e-books that are actually changed are updated and not the entire bookshelf.

The system will also synchronize with e-reader content server 112 the fact that a supervisor permanently deleted an e-book from the server bookshelf using the e-reader. This mechanism can be based on a specific API call or on the exchange of information.

| Field name | Description |
|---|---|
| ISBN 13 | One per each e-book or sample chapter in the server bookshelf. ISBN |
| | identification number for the e-book. E-books and the corresponding |
| | sample chapters share the same ISBN. |
| E-book qualifier | One per each e-book or sample chapter in the server bookshelf. |
| | Indicates if the e-book is a free e-book, a sample chapter, or a paid-for |
| | e-book. |
| User | One per each combination of e-book or sample chapter in the server |
| bookshelf | side bookshelf and e-reader user profile account or supervisor account. |
| assignment | Indicates whether that e-book or sample chapter is assigned to that user |
| | bookshelf. |
| User | One per each combination of e-book or sample chapter in the server |
| favorite | side bookshelf and e-reader user profile account or supervisor account. |
| assignment | Indicates whether that e-book or sample chapter is marked as a favorite |
| | for that user. |
| E-book version | One per each e-book or sample chapter in the server bookshelf. |
| | Indicates the current version of that e-book. |

Top 10 List—This information is only synchronized from e-reader content server 112 to the e-reader.

| Field name | Description |
|---|---|
| Title | E-book title. |
| Author | E-book author. |
| Front cover URL | URL for the download of the JPEG |
| | image for the e-book front cover. |

E-book Metadata—This information is only synchronized from e-reader content server 112 to the e-reader. This information is synchronized when a new e-book or sample chapter has been added to the server bookshelf. When the e-reader synchronizes the bookshelf information and finds a new e-book or sample chapter, it proceeds to request the additional metadata. This information is also synchronized when a new version of an e-book becomes available. Notification to the e-reader occurs via bookshelf synchronization. The e-reader will proceed to request again the metadata for that e-book and download new cover page images and e-book files as required. This process ensures that these cases are managed properly in the event that the new e-book version includes a different cover or a different set of e-book files for various resolutions.

| Field name | Description |
|---|---|
| Title | E-book or sample chapter title. |
| Author | E-book or sample chapter author. |
| E-book Type | Picture book, level read, chapter book, or young adult. |
| Front cover URL | URL for the download of the JPEG image for the e-book front cover. |
| Back cover URL | URL for the download of the JPEG image for the e-book back cover. |
| Spine URL | URL for the download of the JPEG image tor the e-book spine. |
| E-book file size | E-book or sample chapter e-book file size. |
| E-book file screen | For each e-book metadata set and for each e-book file for that e-book, |
| size metadata | the metadata that specifies the screen sizes supported by that e-book file. |
| E-book file URL | For each e-book metadata set and for each e-book file for that e-book, |
| | the URL for the e-book file is downloaded. |
| E-book version | The e-book version used to automatically manage updates of the |
| | metadata, cover pages, and/or e-book files. |
| Minimum e-reader | The minimum required version of the e-reader required to fully access |
| version required | the content of the e-book and all its features (typically interactive mode). |
| Enhanced e-book | Indicates if the e-book is an enhanced e-book. If this is the case, the |
| Flag | enhanced e-book logo may be presented on top of the cover page in |
| | the bookshelves. |

E-book reading-related information—This information group applies to any combination of e-book (complete e-book and/or sample chapter) and user (supervisor or e-reader user profile). This information group may be synchronized in both directions (from e-reader content server to e-reader and vice versa) every time the user reads an e-book.

The following group of information elements will be synchronized from the e-reader to e-reader content, server 112 every time the e-book is accessed for reading. This same group of information elements is then propagated from e-reader content server 112 to the other e-readers. When uploading annotation and highlight information from the e-reader to the server, an incremental approach is preferred (i.e., one in which only new annotations, annotations changes, and annotations deletions are transmitted).

| Field name | Description |
|---|---|
| ISBN | ISBN of the book for which the reading status is being reported. |
| E-book qualifier | Used in combination with the ISBN above. Whether the e-book for |
| | which reading progress is being reported is the complete e-book. |
| User | Unique user identification number of the e-reader user for which |
| | the reading is being repeated. For supervisors this is the e- |
| | commerce website ID. For e-reader users, this is the unique e- |
| | reader user profile identifier (e.g., their name and/or birthdate). |
| Bookmark | The bookmark for that e-book and e-book user combination. |
| Annotations | For each annotation for each e-book/user, the following information: |
| | Annotation start point, page |
| | Annotation start point, coordinates within page |
| | Annotation unique ID |
| | Annotation text |
| | Whether the annotation is being created, modified, or deleted. |
| Highlights | For each highlight, for each e-book/user, the following information: |
| | Highlight start page |
| | Highlight start point, start word index within the start page |
| | Highlight end page |
| | Highlight end point, end word index within the end page |
| | Highlight color |
| | Whether the highlight is being created or deleted |

If a user tries to create a new highlight with the same exact starting and ending coordinates and the same highlight color, the second highlight will be ignored. The same applies if a server is attempting to synchronize any such highlight.

Reading statistics synchronization—The following group of information elements will be synchronized from the e-reader to e-reader content server 112 every time the e-book is accessed for reading to maintain the user's reading statistics. This information is therefore transferred to the server only if the supervisor of the user has set the corresponding parameter in the user profile. This group of information elements is not propagated to the other e-readers.

| Field name | Description |
|---|---|
| Dictionary lookups | Number of words looked up in the |
| | dictionary in this reading session. |
| Words looked up | Words looked up in the dictionary in |
| | this reading session. |
| Time started | The timestamp the user started reading |
| reading | this e-book for this session. |
| Time spent reading | The time the user spent reading this |
| | e-book for this session. |
| Number of | The number of times the user performed an |
| interactive mode | activity within interactive mode, i.e., used |
| interactions | interactive content-reinforcing media. |

Reading statistics information will only be synchronized from e-reader content server 112 to the e-reader when the supervisor user requests this information, i.e. the supervisor navigates to the bookshelf management pages within the Supervisor Tools. Three approaches are possible:
When reading reports are kept up to date on e-reader content server 112, no calculation has to be performed at the time that the e-reader requests the information. The aggregate information may be retrieved from the user record.
When the user accesses the Reading Reports page, reading reports for all the e-reader user profile accounts are calculated and retrieved from e-reader content server 112 to the e-reader.
When the user accesses the Reading Reports page, an inquiry to the database of e-reader content server 112 will only be made for the requested report of the e-reader user. If the supervisor has multiple e-reader user profiles and wants to see more than one report, each report view will generate a separate request to the server.

The following is the list of Reading Reports metadata information that will be replicated for each user from e-reader content server 112 to the e-reader. The list also indicates where this information is presented.

| Field name | Description | Where does the information appear |
|---|---|---|
| Last number of | The N e-books that have been | Reading reports page for each profile, in |
| e-books read | opened most recently in a specific | Supervisor tools both for the e-reader and |
| | profile/bookshelf. The | the Web Supervisor tools. |
| | presentation elements will include the: | |
| | E-book title | |
| | Cover page image | |
| | Date when it was read | |
| | Duration the book was opened | |
| | Page that was reached in that | |
| | reading session | |
| | A unique entry is characterized by | |
| | the same e-reader user profile, e- | |
| | book, and time the book was | |
| | opened. Therefore the number of | |
| | entries can in principle be about | |
| | the same e-book being read in the | |
| | same day. | |
| Number of e- | This is the number of e-books that | Reading reports page for each profile, in |
| books opened | the user has opened ar least once. | Supervisor tools both for the e-reader and |
| | This includes purchased e-books, | the Web Supervisor Tools. |
| | free e-books, and sample chapters. | |
| | If the profile owner opens both the | |
| | sample chapter and the purchased | |
| | e-book for the same title, these | |
| | will count as two. This | |
| | information is provided for three | |
| | time intervals: | |
| | The past week | |
| | The past month | |
| | □ Since the creation of the user | |
| Time spent reading | This is the cumulative time logged | Reading reports page for each profile, in |
| | reading by the e-readers associated | Supervisor tools both for the e-reader and |
| | with the e-reader user profile. This | the Web Supervisor Tools. |
| | information is provided for the | |
| | same three time intervals as | |
| | indicated above. Time is presented | |
| | in days, hours and minutes. | |
| Pages turned | This is the cumulative number of | Reading reports page for each profile, in |
| | times the user has moved to the | Supervisor tools both for the e-reader and |
| | next page in any of the e-books | the Web Supervisor Tools. |
| | they have read. This information is | |
| | provided for the same three time | |
| | intervals as indicated above. | |
| Words in dictionary | This is the cumulative number of | Reading reports page for each profile, in |
| up | times the user has looked up a | Supervisor tools both for the e-reader and |
| | word in the e-reader dictionary. | the Web Supervisor Tools. |
| | This information is provided for | |
| | the same three time intervals as | |
| | indicated above. | |
| Story interactions | This is the cumulative number | Reading reports page for each profile, in |
| completed | of times the user has responded | Supervisor tools both for the e-reader and |
| | with the proper action (not | the Web Supervisor Tools. |
| | necessarily the correct answer | |
| | though) to any of the activities | |
| | provided in Interactive mode in | |
| | certain e-books for any of the e- | |
| | readers associated with the | |
| | account. This information is | |
| | provided for the same three time | |
| | intervals as indicated above. | |
| Dictionary use | The last number of words | Supervisor tools |
| | looked up in the dictionary by | Each profile tab |
| | that profile. | Right side pane |
| Specific e-book | The bookmark value for that | Supervisor tools. |
| reading report | e-book and the total number | Each profile tab |
| | of pages for that e-book. | In the pop-up window that appears when |
| | | the user hovers on the e-book. Note that |
| | | this specific information (where the e- |
| | | reader user is in this book) will not be |
| | | displayed in the profile page if reading |
| | | reports are turned off. |

If the aggregate reading statistics are calculated for the past week and the past month starting from the detailed reading records and dynamically aggregating the information, a single query should be placed to the database to extract the detailed information. The extracted detailed information should be added up to calculate the values for the past month and the past week.

For certain books in which text and images are combined together (typically picture books and early readers), it may be necessary to create multiple e-book versions for different screen resolutions. The different versions will differ in the size of the text with respect to the size of the whole page. This will prevent the text to be too small if the page is rendered on a small screen.

In one embodiment, the e-book metadata will contain an XML formatted field that will include the mapping between the screen sizes and the XPS versions supporting those screen sizes. A minimum screen size and a maximum screen size will be provided for each E-book file. In the vast majority of cases a single E-book file will support all screen sizes (this will be the cases for all text only books) in which text can be resized or zoomed in.

Supervisor Tools

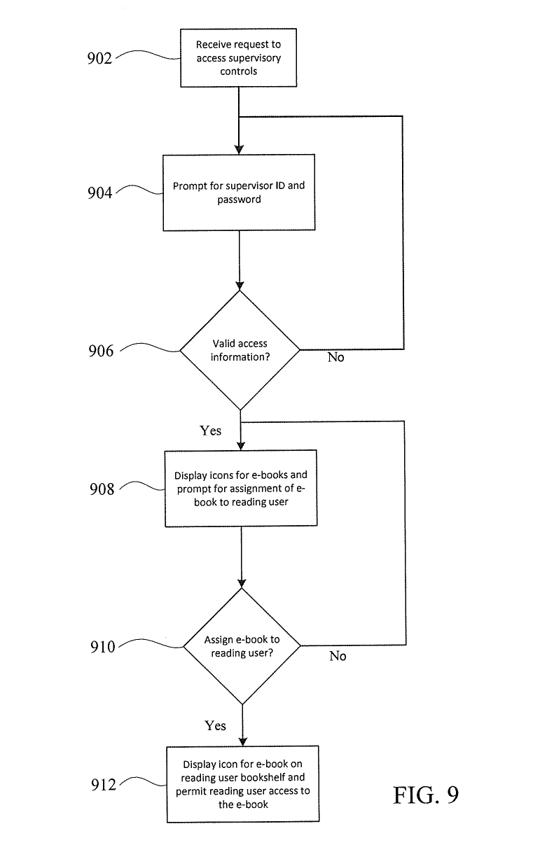

The Supervisor Tools or Parent Tools section may be accessed by clicking on link 708 on the home page as shown in FIG. 7, which requests access to the Supervisor Tools section as shown in box 902 of FIG. 9. The user is prompted for the password associated with the e-reader account in box 904, which is validated in decision box 906. The validation may occur locally or at e-reader content server 112. The requirement of validation ensures that the e-reader users do not have access to the Super Tools.

When the user arrives at the Supervisor or Parent Tools page, if there are updates to the software, a pop-up may appear notifying the user that a software update is available. If updating is chosen, a progress bar appears notifying the user of the update status. The program is frozen during this update. If there are updates to any of the individual e-books, a different pop-up may appear. All of the e-books that have updates are listed. If there are more than can fit in the space, a scroll bar is introduced. Clicking “Update Now” will begin the download of the updated books. Unlike the software update, this update happens in the background and the books behave as if they were downloading for the first time, showing progress bars within the reading interface. Neither of these pop-ups appears if the reader is in disconnected mode.

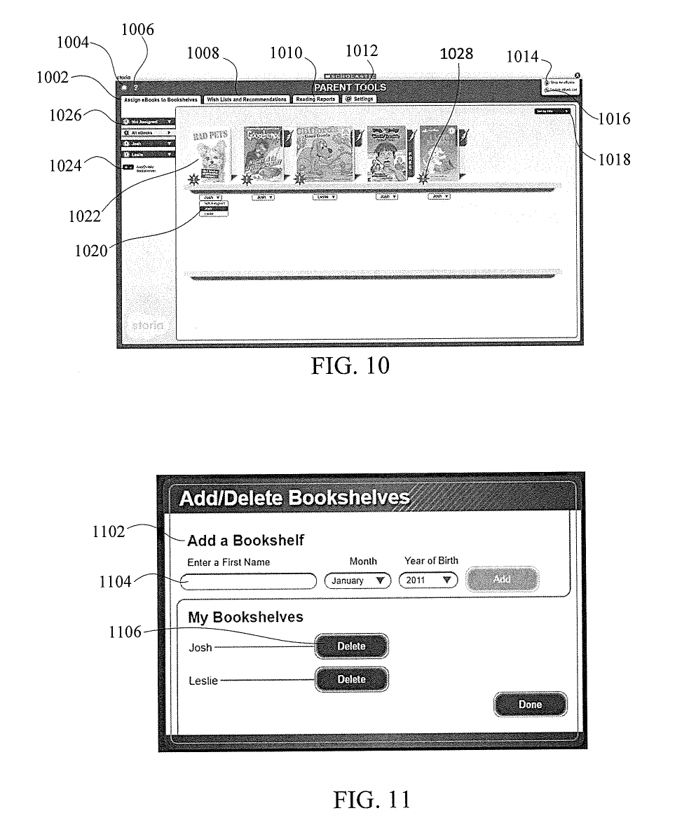

The Supervisor Tools page is shown in FIG. 10. From here, the user can create, bookshelves, organize books on shelves, and access all other account tools and settings. The areas of functionality are accessed by tabs along the top of the screen. The default tab is tab 1002 “Assign eBooks to Bookshelves”. The user may access additional functionality by clicking on tab 1008 “Wish Lists and Recommendations”, tab 1010 “Reading Reports” or tab 1012 “Settings.” The page also shows e-book icons 1022. Various marks 1028 may appear on books such as “Sample” indicating that it is a sample of a book, a lightning bolt icon indicating that the book is an enhanced book, and a red exclamation point icon indicating that the book is not compatible with the current version of the e-reader.

When tab 1002 “Assign Books to Bookshelves” is Chose, the e-book collection is shown in the main area of the screen. Along the left margin are tab filters 1026 for the collection: (1) “Not Assigned”—shows only those e-books that have not yet been assigned to any bookshelf; (2) “All eBooks”—Shows all e-books; and (3) each individual bookshelf—Shows e-books that are assigned to individual bookshelves. If there are unassigned books, the default filter is “Not Assigned”. If there are assigned books, the default filter is “All Books”. Next to each filter button, a number indicates the number of books that are currently assigned to that filter.

At this point, books may be assigned or re-assigned as shown in box 908 and 910 in the flow chart of FIG. 9. As shown in FIG. 10, beneath each book is a pull down menu 1020 that shows the bookshelf to which the book is currently assigned or, for books that have not yet been assigned, shows the book as “Not Assigned”. To reassign a book, the supervisor changes the value in the pull down menu. If the supervisor assigns the book in a way that should cause the book to no longer be shown within the current filter (e.g., while filtering for “Josh” assign a book to “Leslie”), the book does not disappear until refreshing of the filter, but the numbers next to each filter update immediately and the filter to which the book was added flashes subtly to mark the change. As the selections are made, the assignments are updated and access is provided based on that assignment as shown in box 912 of FIG. 9.

When the cursor icon is caused to hover over an e-book icon, or an e-book icon is touched and held on a touch sensitive display, a hover may appear over the e-book icon. This hover may show the title and author of the book and may have two buttons: “Delete Book” and “Preview.” The “Delete Book” button is used to permanently delete a book from the online library, meaning that the book will be permanently deleted from all devices. When this button is pressed, a final deletion warning appears. Pressing “Delete” deletes the book forever. Pressing Cancel backs out of this screen. If the device is not connected to the Internet, this screen instead shows a message that says, “The user must be connected to the Internet to permanently delete a book from the collection.”

The second button within the book hover is “Preview”. This opens the book within the reading interface. The book behaves as usual except that the user cannot create notes or highlights, the page number is not stored, and no reading records are kept.

The Preview function is available only if the book is set to “Not Assigned”, as a legal constraint. If the book is assigned to an e-book user profile, the “Preview” button is grayed out and a small link at the bottom of the hover says, “Why can't I preview this eBook?” Follow that link and the content of the hover is replaced with a message that says, “This eBook is already on [name's] bookshelf and so cannot be previewed. To preview the eBook use the pull down menu beneath the book to set the book to ‘Not Assigned”’.

There are two additional ways to organize e-books within the “Assign Books to Bookshelves” tab: Use the “Sort By:” pull down menu 1018 to sort the books by Title, Author or Newest. Newest meaning the most recently purchased. The supervisor may also click on “Hide Sample” to hide sample books. When the supervisor does this the button toggles to “Show Samples”. If the supervisor has either all samples or no samples, this button does not appear at all.

For some e-books in the collection, the e-reader may not be updated with either the requited or the recommended version of the e-reader software. If the e-reader is not up to the required version, a graphic appears over the cover of the book. When the user hovers over the book, the hover menu describes the problem. If the software meets the required version for the book but not the recommended version, the red exclamation mark does not appear, but the fact is noted in the hover.

To add or remove bookshelves, a user can click the “Add/Delete Bookshelves” button 1024. A pop-up menu opens as shown in FIG. 11. To add a new bookshelf, the user must fill in the first name in slot 1104, enter the birthdate information using the pull-down menus, and then click the Add button. The new bookshelf appears immediately in the “My Bookshelves” area at the bottom of the screen. If there are ten bookshelves (the maximum allowed in one embodiment), the entry fields under “Add a Bookshelf” are replaced by a message that says, “The user already has the maximum number of bookshelves. The user will have to delete one before creating more.” The bottom half of the screen is used to show existing bookshelves. To delete a bookshelf, a user can click Delete button 1106 next to the bookshelf name. A pop-up window says, for example, “Are you sure you want to delete this bookshelf? All reading records associated with this bookshelf will be permanently lost and all books on this shelf will become unassigned.” There are two buttons within this pop-up, “Delete” and “Cancel”. If the user clicks the “Delete” button the bookshelf disappears from the list.

If the e-reader is not connected to the Internet, the supervisor cannot add or remove bookshelves. The “Add/Delete” button appears grayed out on the main supervisor tools screen and has an information icon next to it. A hover on this icon gives the user the message, “To add or delete bookshelves, the user must be connected to the Internet.”

Any place that the e-reader user is shown books that they do not yet own, they are given the option to add the book to their wish lists. They might see these books in various locations, such as, “In the Top 10 List” or as a recommendation at the end of another book. Wherever an un-owned book appears, a button may be associated with the book that says, “Add to Wish List.” There are three possible states that may occur when a user clicks the “Add to Wish List” button:

1) If the book has not been added to the wish list and the book is not on the bookshelf the button shows an empty checkbox with the text, “Add to Wish List”. Click on this text or the checkbox and the book is added to the wish list. The button also toggles testate number 2, described below.

2) Once a book is on the wish list, the checkbox is checked and the text says, “On My Wish List”. This text may be selected again to remove the book from the wish list, also causing the button to revert to state number 1.

3) If the book is already on the bookshelf the checkbox is checked and the text says, “On My Bookshelf”. The button cannot be clicked when it is in this state.

All of the books that have been added to the wish list are aggregated in Supervisor Tools, in a “Wish Lists and Recommendations” tab 1008. The screen shot of tab 1008 is shown in FIG. 12, and it is categorized by e-reader user profile. All of the books that they have added to each wish list are shown as thumbnail covers. If needed, a horizontal scroll bar is used to show all of the books. A screen hover shows the title, author and the date the book was placed on the wish list. If a user clicks the “Sample or Purchase” button a browser opens connecting the user to the e-commerce website, and displays the product page for the specific book. If a user clicks the “Remove from List” button this will remove the book from the e-reader user's wish list. The book will disappear immediately from the panel.

It is possible that au e-reader user places a book on the wish list that is already purchased, but that is not yet assigned to that e-reader user's bookshelf. In that case, au additional message says. “The user already own this e-book, but it's not assigned to [e-reader user's name].” In this scenario, the “Sample or Purchase” button does not appear. In addition to this interface, e-reader user profile wish lists may be sent to supervisors by e-mail. These e-mails are sent whenever a book is added to a wish list, but never more than once per day. All wish list additions are saved until a specific time each day, at which point the e-mails are sent. This e-mail can also include an opt-out link.

After the last page of each e-book, an additional page is generated showing other books that the e-reader user may like. This additional page has the appearance of a page, but is not actually part of the e-book file and instead is generated programmatically. The books that appear on this pap are pulled from three possible sources: (1) books 1 mm the same series; (2) general recommendations; and (3) spotlight books. General recommendations are books that the user might like based upon their overall reading habits. Spotlight books are books that are promoted at a certain time, for instance for an important new launch. These books are coded to a specific book category, for example, Young Adult (“YA”) Books, Picture Books, and will then show up in the back of all books within that category. Spotlight books may be visually differentiated from other books, for example, put into a frame. At any time, there could be no spotlight books in a given category, or multiple spotlight books. If there are more than one spotlight books in a category, the spotlight, books are cycled through each time a book is opened in that category.

Whenever a book appears as part of the recommendations, it is shown with a thumbnail version of the cover, the title and author. The book also includes an “Add to Wish List” link. There is one additional special case: sample books. The recommendation page in the back of a sample book includes only the full version of the same book. Again, the “Add to Wish List” link is included. In implementing this functionality, e-reader content server 112 may store which books are part of a series, the order of books in the series and current spotlight books.

Recommendations are also presented within Supervisor Tools in “Wish Lists and Recommendations”, as shown in section 1206 of FIG. 12. These recommendations respond to each e-reader user's aggregate reading habits. The recommendation algorithm may draw, for example, on what books each e-reader user has read, how much time they spent with each book, the ratings that they gave each book, the number or words looked up within each book, the number of interactive, games, puzzles or quizzes used in each book, a calculated average of a number of these factors (such as, the time spent per number of words in the book) and similar information. The algorithm can provide a weighted average for any or each of these factors. As another example, the algorithm can take into account the age and reading level of the reader through analysis of the reading level of the book as compared to the reader's actual reading performance. This provides an objective basis for providing recommendations for further reading as opposed to the more subjective evaluation provided by user ratings of e-books.

Like the wish list hover, there is the option to “Sample or Purchase” the book directly through a link to the e-book's product page. An “Ignore” button may remove the book from the recommended list and replaces it with the next most likely book suggested by the recommendation algorithm. If the book is already owned, but it is not assigned to the e-reader profile whose recommendations are being viewed, the purchase button is replaced by a note that says. “The user already OWE this e-book, but it's not assigned to [e-reader user's name].” There may be an option to the Settings screen in Supervisor Tools for supervisors to suppress the recommendations in the back of books.

When a supervisor clicks the “Purchase” button associated with any e-book in the Wish Lists and Recommendations tab, a Web browser is opened to the product page specific to that e-book. Users may be able to read sample e-books without having an e-reader content server or e-commerce website account or need to sign in. An option can be given at a welcome screen to permit a sample bookshelf with free books to try immediately.

Books may be opened, rearranged or a theme may be chosen. “Home” button 1004 on the bookshelf takes the user back to the home screen, from which the user may choose another bookshelf.

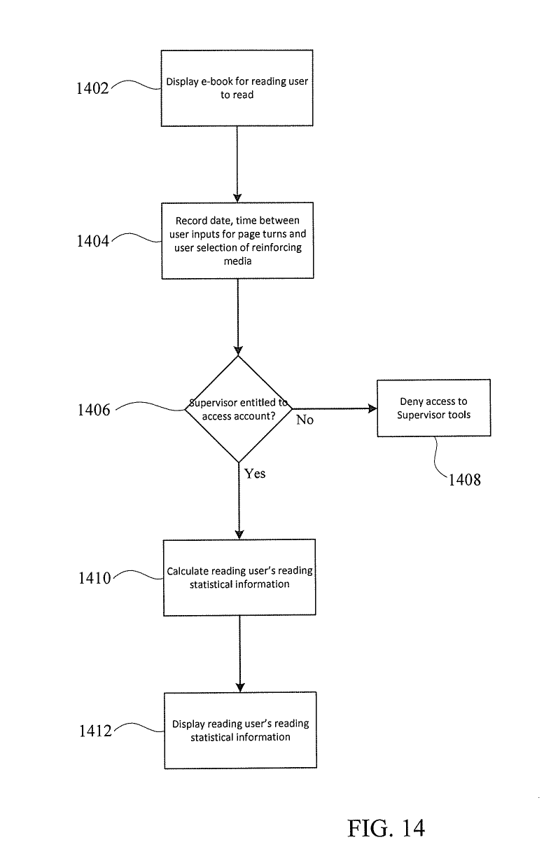

The e-reader of the present invention provides the ability to track and report reading activities of the e-reader users. A flow diagram of this process is shown in FIG. 14. During e-reader use by an e-reader user in block 1402, the e-reader software tracks reading information as shown in block 1404. This may include when books were opened, how many times they were opened, time spent reading, time spent on each page, interactive activities engaged in by the e-reader user, books browsed, results of content-reinforcing quizzes and activities, and any other information relating to reading activities. This information may be stored on the e-reader or at e-reader content server 112. In one embodiment, access to reading reports is limited to supervisors through password protection as shown in blocks 1406 and 140S. Once access is validated the e-reader calculates a summary of the e-reader user's reading activities in block 1410. For example, the e-reader may record time stamps for each access, page turn and activity. Then, the e-reader software may calculate the time spent reading by determining the time spent displaying each page as opposed to time spent engaging in other activities such as quizzes, puzzles and other content-reinforcing activities. The supervisor is then provided with a summary of the e-reader user's statistical information in block 1412.

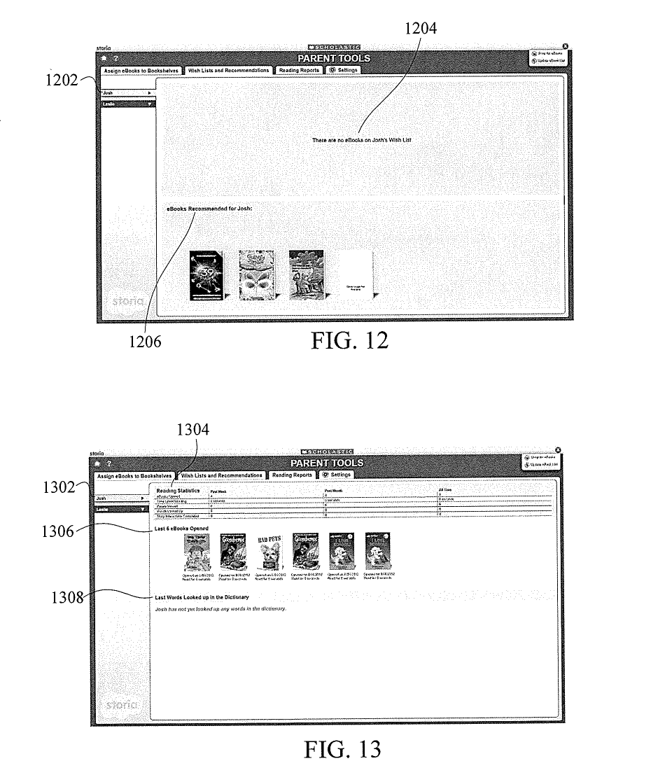

An example of the page showing the reading reports tool is shown in FIG. 13. Along the left margin are the bookshelf tabs 1302. Clicking on one them provides reading reports for that e-reader user. Each reading report is divided into three sections:

Reading Statistics—This section quantifies how many books have been opened, time spent reading, pages turned, words looked up in the dictionary and story interactions completed for the past week, month, and since the user account's inception. The “past week” compiles the last seven days and “past month” compiles the last 30 days so that these do not reset to zero.

Last 10 Books Opened—This shows the last ten books that were opened. This means the last ten times that any book has been opened, so it could be the same book ten times. Beneath each book is listed the date it was opened, how long it was read for, and the page the e-reader user was on when they closed the book during that reading session. If the e-reader user has not yet opened any books, this section is replaced by a message, “[e-reader user profile name] has not yet opened any eBooks.” If fewer than ten e-books have been opened, all books are shown and the headline changes to reflect the actual number.

Last 10 Words Looked Up in the Dictionary—This lists the last ten words the e-reader user looked up in the dictionary. If they have never looked up any words it says, “[e-reader user profile name] has not yet looked up any words in the dictionary.”

If reading reports is turned off in the account settings, the entire content of this tab is replaced by a message that says, “The user has chosen to turn off Reading Reports. Go to Settings to turn them back on.” In this case, the bookshelf names are not shown on the left.

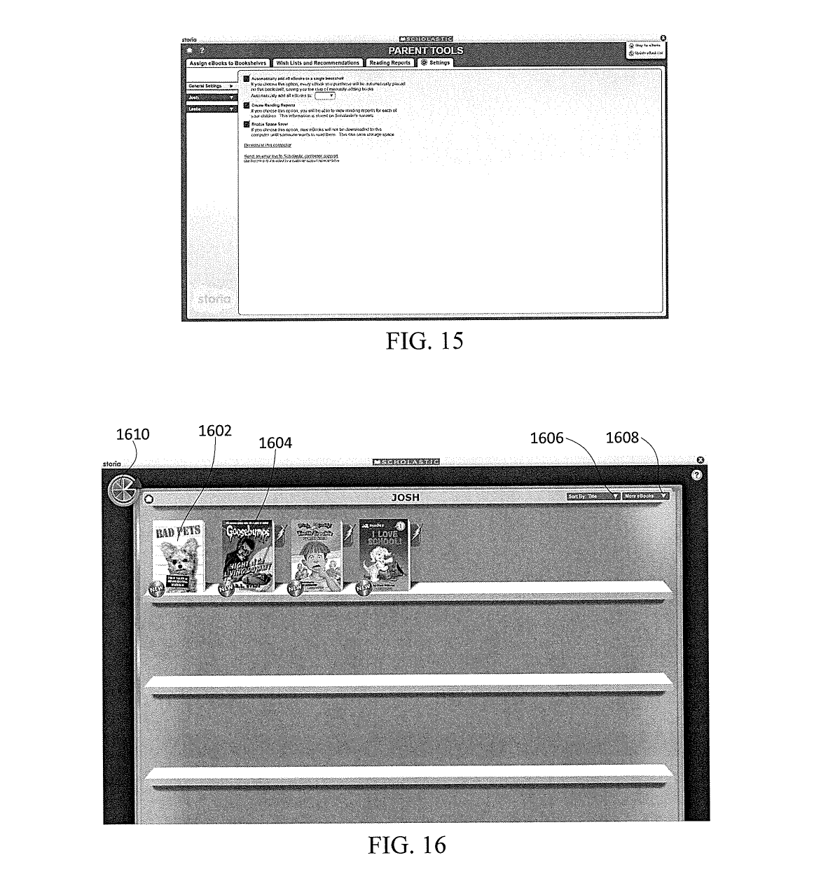

The settings for the e-reader may be changed in the settings page of the Supervisor Tools section. A sample of the screen is shown in FIG. 15. The tab defaults to “General Settings”, which offers the following functions:

Automatically add all e-books to a single bookshelf—Every book purchased from this point forward will be automatically assigned to a single bookshelf. Once this option is checked, a second pull down menu appears with which the user specifies the bookshelf to which books are automatically assigned.

Create Reading Reports—This option enables reading reports by allowing reading data to be stored on the e-reader content server. This default for this option is typically enabled.

Enable Space Saver—This option affects only the current device and ensures that new books are not downloaded immediately to the computer. Both within Supervisor or Parent Tools and on e-reader users bookshelves, new books are represented as translucent and begin to download only when someone wants to read it.

Check for Software Updates—This option checks for software updates.

Send Error Logs to e-reader content server—This option sends the error log to customer service at the e-reader content server.

Deregister this Computer—This option de-registers the e-reader and all personal information is removed from the computer. When the process is complete, the software automatically quits. If launched again, it behaves as if it had just been installed for the first time.

The settings for any individual bookshelf may be changed by choosing one of the buttons along the left margin. On this screen, the user can change the following settings: the e-reader user's name and month/year of birth; the bookshelf style; allow the e-reader user to set a password for his or her bookshelf; and enable/disable story interactions.

Bookshelves may also be deleted from this screen. The following functions are not available when the e-reader is disconnected from the Internet:
Change the e-reader user's name for any bookshelf.
Change the setting that allows an e-reader user to set his or her password.
Change the Setting that controls automated assignment of e-books.
Change the setting that controls whether Reading Reports are generated.
Send the error log to the e-reader content server.
Check for software updates
Deregister the device.

The interface for all of these settings appears grayed out when in disconnected mode. An information icon appears next to each setting, and when the user rolls over the icon, the user gets a hover message in the form “To change a bookshelf name, the user must be connected to the Internet.”

Reading on the E-Reader

The bookshelf screen as shown in FIG. 16 is the access point to all of the purchased books that the supervisor has assigned to a particular e-reader user profile. This screen is accessed by pressing buttons 702 or 704 from the home screen shown in FIG. 7. There are two versions of the bookshelf, one for older e-reader users and one for younger e-reader users. The biggest difference between the bookshelf versions is the graphic design. The younger bookshelf is more colorful, with chunkier graphics to represent features. The older version is sleeker and more functional, more akin to “adult” readers. The older version also gives the ability to sort books in more complicated ways.

If the supervisor has chosen not to enable passwords for a particular bookshelf, the bookshelf is displayed immediately. If the supervisor has enabled the password option, either the user will be prompted to create a password or to enter the password which was previously set.

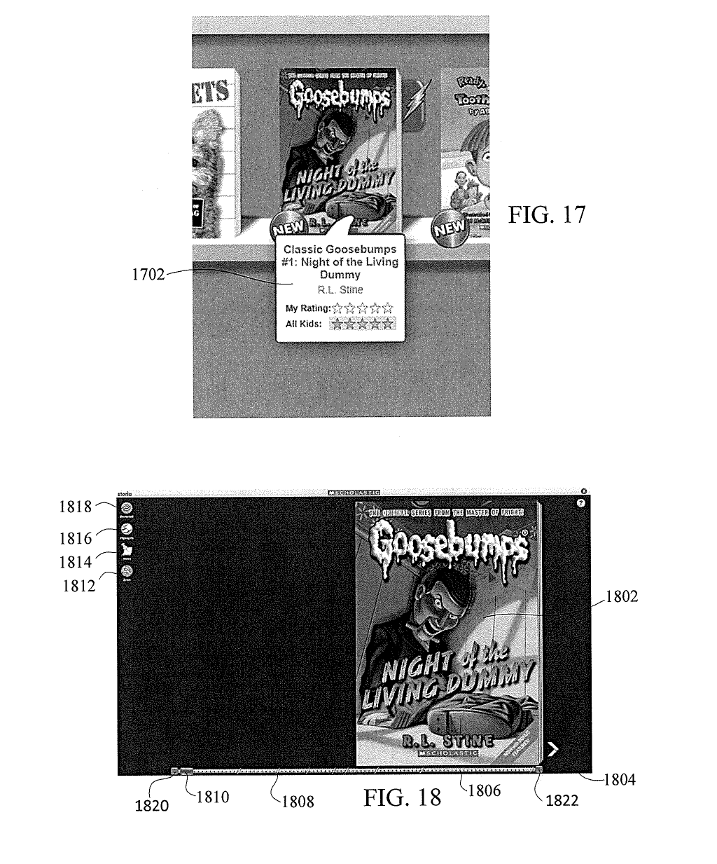

E-books 1602 appear on the bookshelf as thumbnail covers and may be marked with various distinctive icons 1604 such as “new”, “favorite”, “enhanced”, “best seller” or the like. If there are more books than can fit on the shelf, additional shelves are added off screen and a scroll bar appears in the right margin. Rolling over any book on the shelf may provide a hover 1702 as shown in FIG. 17 that gives the book's title, author and personal rating and a rating by all users. The bookshelf may be re-arranged by dragging and dropping the books on the shelf. When a book is re-positioned, it slots into its new spot, pushing other books to the right and/or below it to the right and down. There is also pull down menu 1606 that allows books to be ordered in common ways such as title, author, last read, newest, favorites and the like.

Submenu 1610 on the bookshelf permits the user to choose one of several themes. These themes are colored backgrounds with subtle patterns that fill in the space around and behind the bookshelf itself. They are also carried through to the reading interface, where they fill the space around the book.

The user may click or select the book to start reading. Au animated transition takes the user to the reading interface, which is shown in FIG. 18. In one embodiment, YA Books, Chapter books and leveled readers open to wherever the user left off reading while picture books always open to the beginning. In FIG. 18, cover 1802 of the e-book is shown. The pages may be turned in any number of ways depending on the input capabilities of the e-reader device. For a laptop or desktop device, clicking on advance arrow 1804 advances to the next set of pages. For touch sensitive devices, pages may be advanced by swiping the page.

The reading interface accommodates different types of books for different age levels, from picture books up through YA novels. The tools offered by the software are offered only for those books for which they are age-appropriate, meaning that the design can allow for tools to be turned of or on based on the type of book.

The replica book view shows a two-page spread, using an exact graphic reproduction of the print book rather than reflowable text. All of the book's original design and layout are maintained. For picture books this approach is a necessity, since there is no meaningful way to separate the content from the layout. Some graphic touches are added to the book in order to make it look more like a book. For chapter books and YA books, there may be a subtle line down the middle for the break between pages and as bit of shading to the right of this line to suggest the curve of the page. Stacked pages are shown behind tire left and right pages to imply the depth of the book, although these do not need to accurately reflect the current page position. All of these touches may be added programmatically.

For books that are almost entirely text (older chapter books, novels, YA books) zoom mode will be replaced by a reflowable text mode. This functions similarly to most e-readers: The text is pulled from its replica layout and flowed back into “pages” that are created on the fly. Reflowable text mode is triggered by a toggle button that replaces the zoom mode button. Only one or the other may be available in a given book. When the button is rolled over, two additional controls appear that allow the user to increase or decrease the font size. When the user enters reflowable text mode, the pagination also becomes fluid, and is recalculated each time the user adjusts the font size.

QuickScroll—

Just beneath the book is quickscroll bar 1806, which the user can use to pimp quickly around a book. The length of the bar represents the length of the entire book and the position of the slider represents the current position.

To scroll quickly, a user may grab and drag slider 1810. As slider 1810 is dragged in either direction, a pop-up overlay shows the page number, chapter, and a thumbnail of the page the user is on, but the e-reader does not actually go to a different page until release of the mouse. When released, a rapid page flip animation plays that looks like the blur of many pages going by, leaving the reader on the selected page. Buttons 1820 and 1822 at either end of the quickscroll bar jump with one click to the front or back of the book.

For books that have story interactions, the locations of the story interactions are represented as icon 1808 along the length of the quickscroll bar. The user can click directly on one of these icons to jump to the page with the story interaction. Icons within the thumbnail also show pages that have story interactions, notes, or highlights.

Zoom Mode—

When using exact graphic reproductions, the text cannot reflow, limiting the ability to resize the text and causing problems on small-screen computers like netbooks. To address this, there is a “zoom mode,” in which the user zooms in close on a single page of a book rather than a spread. This view is triggered by pressing “Zoom” button 1812.

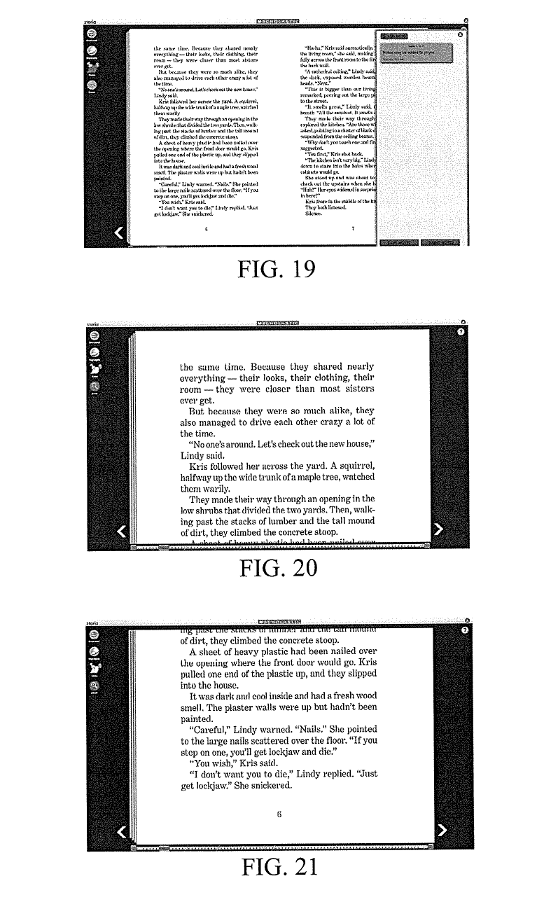

The normal page layout is shown on FIG. 19. When zoom button 1812 is pressed, for chapter books and YA books, the reader zooms in to show the top half of a page as shown in FIG. 20. When the paged is advanced, rather than go forward an entire page, the e-reader display automatically pans down the current page, showing either the bottom half of the page as shown in FIG. 21. On reaching the end of a page on the left side of the spread, it automatically pans to the top of the next page. When the end of a page on the right side of the spread is reached, it zooms out to show the page turn, then zooms back in to show the top left corner of the following spread. The effect is to allow the pages to be seen up close without having to pan manually. The amount of the page shown may differ. For example, one third or one quarter of each page may be shown at one time.

For picture books and leveled readers, a more customized version of this approach is used. The zoom points are defined as rectangles and defined manually for each book.

Notes—

Notes are stored in a notes sidebar. To open this sidebar, notes button 1814 is pressed on the left side of the screen. Within the notes pop-up is a button to “add note.” Press this button is used to add a note to the page the user is currently on. A new note appears, which can then be edited. Notes created in the last week show the day of the week they were created and the time. Older notes show the date on which they were created in the format “mm/dd/yyyy” and the time.

Notes are organized by the spread for which they are written, in numerical order through the book. For example, a note written for page five is listed before one written for page thirty, regardless of the order in which they are written. Once there are more notes than can fit in the pop-up, a scroll bar appears, allowing the user to scroll through them. In this case, the slider is automatically positioned so that notes for the current page appear in the center. There can be any number of notes for a single page, and within a page notes can be can dragged and dropped to reorder them. When a note is hovered on, a delete button appears, which when clicked deletes the note. The notes may be saved and printed.

Highlighters—

When the user rolls over highlighter button 1816, it appears to “open up”, showing a number of colors to choose from. A user can click on one of these colors to start highlighting. The user may then click and drag the cursor across any area of text to highlight the text in the chosen color. When the user hovers over a highlight, a small, delete button appears over the highlighted area. Click this button to delete the highlight.

To close the book, a user can press “Back to Bookshelf” button 1818 on the top of the screen. For picture books, the book animates closing to the front cover and returns to the bookshelf. For all other books, an animation shows a bookmark being set before the book closes, indicating that the next time the book is opened, it will start at the same place. When a user opens the same book again, it opens to the same page and an animation shows the same bookmark retracting.

Complete Read Throughs—

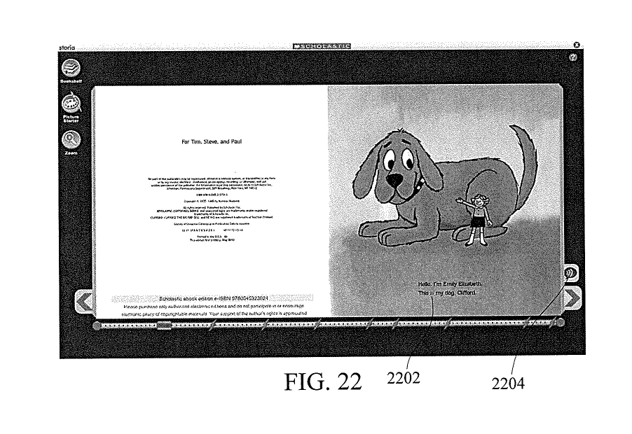

Picture books and leveled readers may have complete voiceover read throughs. As each word is read, the word highlights within the text as shown in 2202 of FIG. 22. The complete read through is triggered by clicking “hear the book” button 2204 that appears next to the right page turn button. When the reader clicks this button, the read through begins on whichever page the reader is on. It then continues automatically, flipping pages as needed. To stop the read through, a user can click hear the book button 2204 again, trigger any other function, or click anywhere on the screen.

If the user triggers a complete read through while in zoom mode, all text currently on the screen is read out loud. The screen then advances through each zoom point automatically, reading the text for each zoom point and then moving on.

Dictionary and Word Pronunciations—

For books that support word pronunciations (picture books and leveled readers), any word may be selected to hear it pronounced out loud. The cursor changes when placed over any word that can be read out loud to indicate that the word can be read. All individual words across all books may be read by a single voice actor, meaning that the voice that reads individual words generally will not match the voice that reads the entire book.

There are two basic versions of the dictionary: the younger dictionary and older dictionary. The younger dictionary is used in picture books and leveled readers. It allows the reader to click on a word to get a definition. The older dictionary is used for chapter books and YA books. The older version of the dictionary allows the user to click on a word to get a definition or to type a word to get a definition.

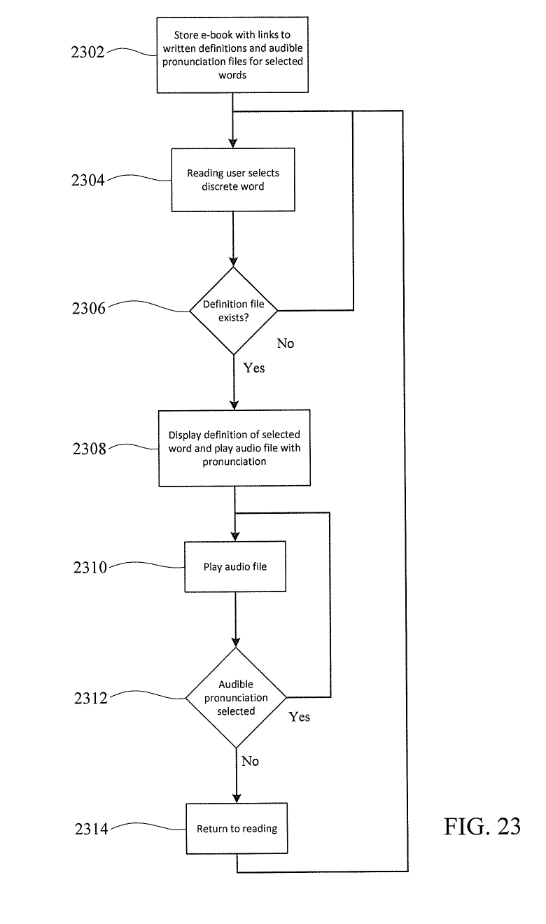

For picture books and leveled readers, the user may click on a word to look it up in the dictionary and have it pronounced. A flow chart of this process is shown in FIG. 23. The e-book is stored in memory with links to written definitions and audio files that provide the pronunciation for the words as shown in block 2302. The e-reader may select any word on the page in block 2304. That word is highlighted and remains highlighted. The e-reader software determines whether a definition and pronunciation exits for the word. If not, then a message is displayed that no definition exists and the reader is returned to the normal reading state. If a definition exists for a word, then the definition is provided to the user and the audio file is played in blocks 2308 and 2310. The pop up may contain an icon allowing the user to replay the audio file. If the user selects this icon, then the audio file is replayed as shown in decision block 2312. The user may return to reading in block 2314 by closing out of the pop up box or touching anywhere on the screen outside of the pop up box.

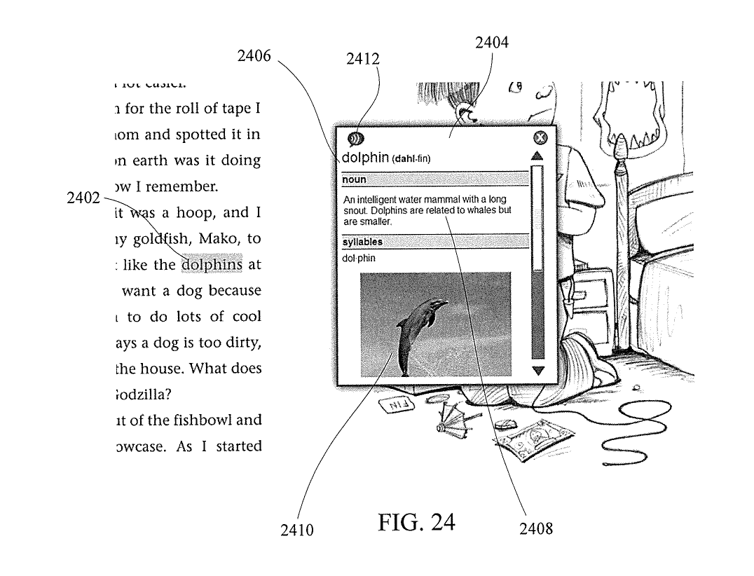

As an example, the word “dolphin”2402 is highlighted in the text in FIG. 24. The definition opens in as pop-up 2404. The pop-up shows headword 2406 and the complete text of the definition 2408. These are read out loud as soon as the pop-up opens. The definition may have picture 2410, and where present, this appears directly beneath the definition. The pop-up also may have “read aloud” button 2412 that causes it to be read again.

A number of variants point to the same headword, meaning that if the user asks for a definition of the variant the user gets the definition for the headword. In general, these variants include plurals, different verb tenses, possessives, comparatives and superlatives.

For chapter books and leveled readers, the user may look up a word by clicking on it directly within the text of the book. At the top of the definition is the headword. Next to the headword is a small button to hear the pronunciation of the word. Beneath this is the complete text of the definition. Some words also have a picture, which appears beneath the definition. Finally, some words have word histories. For these books, the word history appears in a box beneath the picture. Word histories may be shown only if the user is reading a YA book, not for chapter books. In some cases, all of this content may be longer than can fit in the pop-up, in which case a scroll bar is added. Word variants are handled identically here as in the younger version of the dictionary, although the underlying data structure may be different.

If the user searches for a word that is not included in the dictionary, a message states, “This word was not found in the dictionary.” This replaces the definition.

Story Interactions—

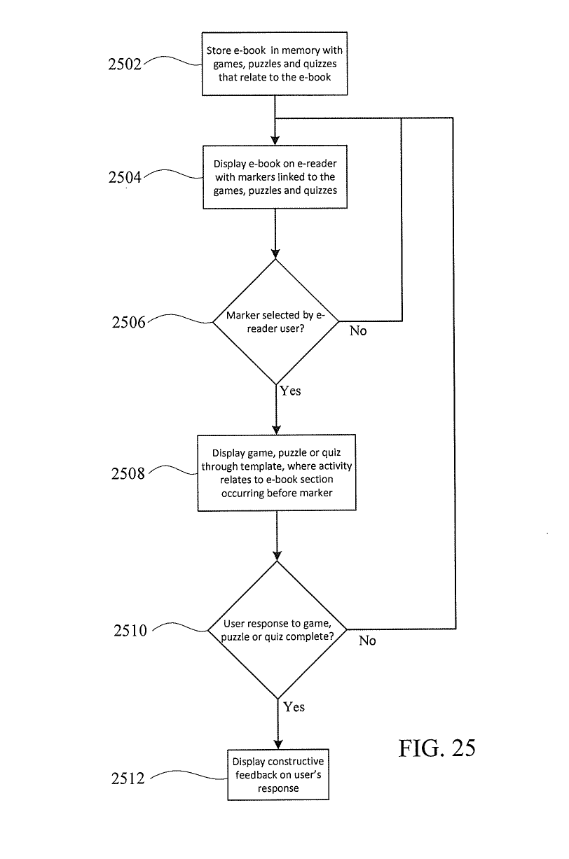

Story interactions (“SI”) are questions, activities and small games that launch on top of the e-book and that supplement and enrich the reading experience. A flow diagram for this feature is shown in FIG. 25. The story interactions are stored in memory and linked to individual pages in the book as shown in block 2502. In block 2504, on each page that includes a story interaction, a small “lightning bolt” icon appears in the upper right corner. This icon activates the interaction when selected by the user in block 2506, which pops up over the page in box 2508. The user can complete the interaction in decision block 2510 or press a CLOSE button to skip the interaction and continue reading instead. Once the story interaction is completed, the user is provided with constructive feedback on the results of the interaction. Story interactions may be optional, and can be turned on or off by the supervisor within the bookshelf settings. When story interactions are turned off, the lightning bolt icons do not appear.

Story interactions are based on templates. A template defines a group of interactions that all use the same logic structure and the same code, although the graphics and content vary. All of the templates are part of the software so that a non-programmer can build new story interactions based on these templates.

The templates may be divided into those for younger e-reader users and older e-reader users. Not only are the two sets of templates functionally different, they have different graphics—bubbly and colorful for the younger e-reader users, and sleeker and more functional for older e-reader users. Each interaction template may appear with a fun entrance. Some interactions may zip in from the side, or bounce down from the top of the page. There may be sound effects to accompany these entrances. Animations may also be used throughout the interaction and when the interaction leaves the screen.

To be accessible to non-readers, all text within story interactions for picture books and leveled readers is read out loud. For instance, for a multiple choice question template, the question is first read out loud by the narrator and then each answer, with each answer being highlighted as it is read. The younger template also has a “read again” button that reads aloud all text currently on the screen.

Voiceover within a story interaction is generally interrupted by any action that closes the story interaction or that triggers a different voiceover. Actions that do neither of these things do not interrupt the voiceover. For example, voiceover is not interrupted by starting to scratch in Scratch & See or picking up a tile in Word Match.

In some cases, the younger e-reader user story interactions have three “problems” on a single page, meaning that if the user clicks the lightning bolt on a page for a second time, the user get a different problem within the same template. In this case, the lightning bolt icon changes to show how many problems the user has done. When the user arrives at the page for the first time, the lightning bolt is red. When the user triggers the story interaction, the one-time introduction plays of there is one). Once the one-time introduction is played, it will not play again. After the user has solved the first problem (for example, of three problems within the template), and the user closes the template, the lightning bolt is animated to show that it is filled up ⅓ of the way. After the user solves the second problem, and the user closes the template, the lightning bolt is animated to show that it is filled up ⅔ of the way. After the user solves the third and final problem, the lightning bolt is animated to show that it is filled entirely, and is shown as yellow. It will stay in this default state perpetually, even if the user continues to cycle through the problems.

Below are various examples of story interactions based on templates. Many other types of story interactions are possible, and these are only exemplary.

Multiple Choice with Text—

The multiple choice template asks a series of multiple choice questions based on the content of the book. In some cases, this template has a one-time introduction, which plays only the first time the user triggers the interaction. The text of this introduction appears in the header box and is read out loud before the answer choices appear. When this voiceover is complete, the first question appears along with three answers. The question is automatically read out loud. Each answer is then read in turn, each answer being highlighted as they are read. The user clicks on an answer. For a correct answer, the button turns green, the answer is read out loud, a voiceover says “That's right,” and alternatively a custom voiceover may provide further feedback or connections of the questions and answers to the story. If the user chooses an incorrect answer, the button turns red, the text for the user's choice is read out loud, and a voiceover says “Try again.” There are three questions for each instance of a multiple choice story interaction, which cycle.

Multiple Choice with Pictures—

This template functions similarly to the multiple choice with text template, except that the answers are pictures rather than text. In some cases, this template has a one-time introduction, which plays only the first time the user triggers the interaction. The text of this intro appears in the header box and is read out loud before the answer choices appear. When this voiceover is complete, the first question appears along with three picture answers. When the story interaction launches, the question is read out loud. Unlike the Multiple Choice with Text template, however, the answers are not read out loud. The user clicks on one of the three pictures to answer the question. The response sequences are similar to those described above, or any number of similar sequences to provide positive reinforcement of the experience.

Starting Letters—

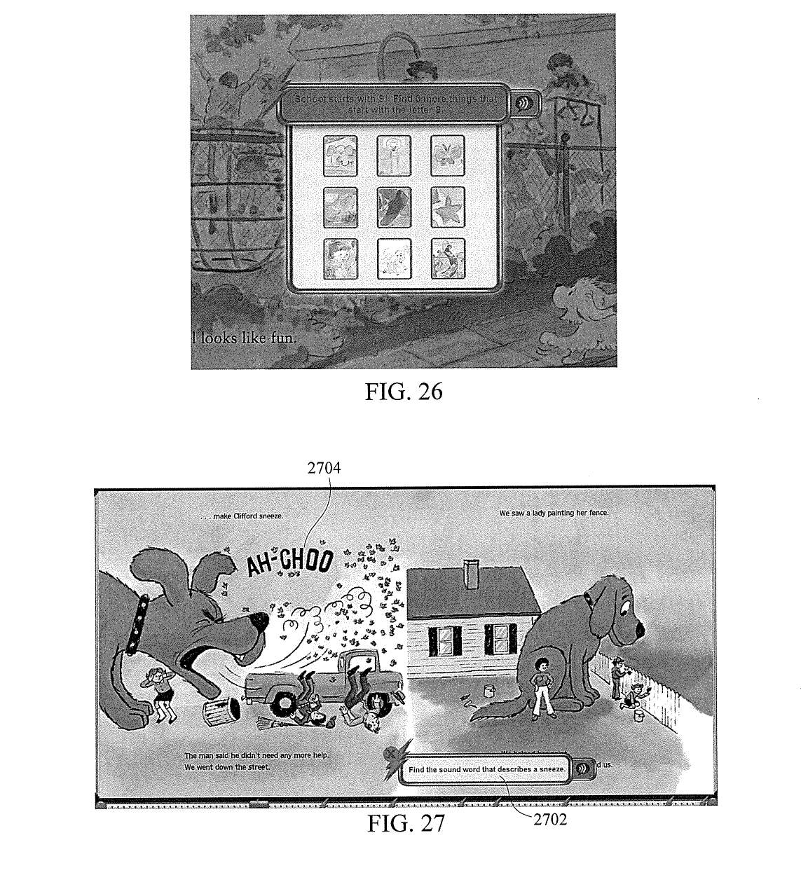

This template gives a letter and asks the user to find all the pictures of things that start with that letter. An example of this is shown in FIG. 26. The pictures are ordered randomly, so that they are in different positions each time. When the template opens, an introductory voiceover is read out loud—e.g., the voiceover may say, “Shell starts with S. Find three things that start with the letter S.”

Word Search—

This is a classic word search game that uses simple words from the story, words that extend themes from the story, or that explore word families. The user is presented with a grid of letters with words hidden in the grid horizontally or vertically; (no words are hidden diagonally). To begin, the user clicks on a letter. The letter highlights and a circle appears around it. The user then drags the cursor in one of the four cardinal directions. When the user hits another letter next to the one initially selected, that letter highlights and the circle grows to an oval that encompasses both letters. The mouse is released to “lock in” the selection. If the word is on the list, a voiceover states the word out loud. The selection oval stays in place and the word is crossed out in the word list in the same color as the oval. The letters that make up the word then return to their neutral state. The next time that the user makes a word, the selection oval will be a different color. If it is not one of the words in the search list, the selection oval flashes white and red with an incorrect sound effect and the voiceover says, “Try again!”

When completed, the selection oval for each word may be a different color, and words in the search list will be crossed out using a colored line that matches the oval. A voiceover will say, “[e-reader user profile name] found them all!” and the story interaction closes. Grids of any size with any number of words are available allowing the game to work for a range of ages.

Touch the Page—

For this template, the user is given a written question, but is not given any answer choices. Instead, the user gives the answer by clicking anywhere on the displayed picture. In some cases, this template has a one-time introduction, which plays only the first time the user triggers the interaction. Where that is the case, the text of this introduction appears in the text box and is read out loud before the first question appears. When the voiceover is complete, the first question appears. An example is shown in FIG. 27, with touch the page question 2702 prompting the user to touch the page where the sound word describes a sneeze, in this instance location 2704 of the words “ah-choo” on the page.

Sequencing—

In this template, the user is shown three images from the story and asked to put them in the order in which they happened. The user drags each of the pictures from the top row to put them in order in the bottom row. When the last picture of the correct sequence is placed in the answer bar, the correct answer response is triggered.

Word Match—

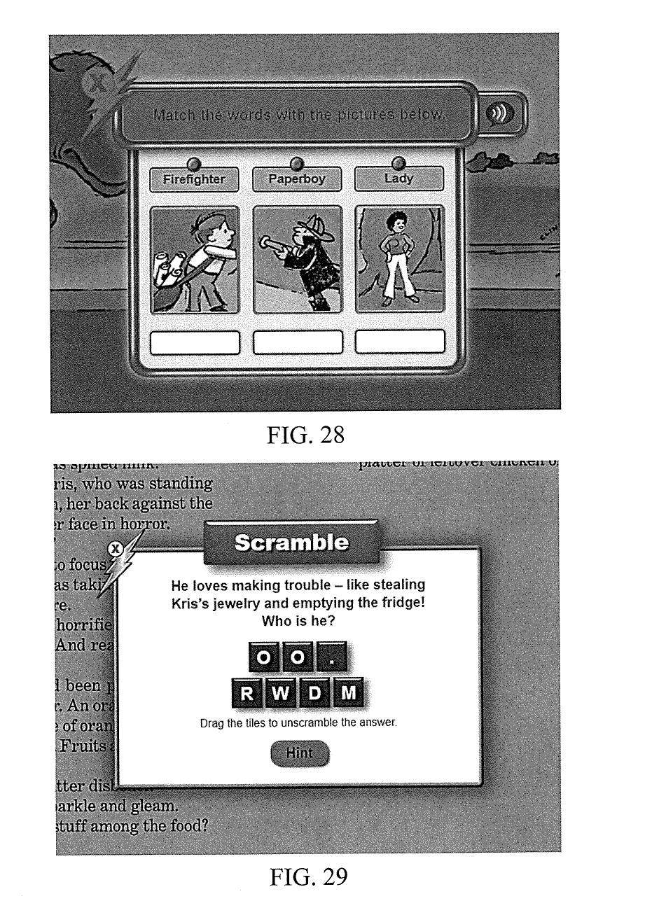

The word match template shown in FIG. 28 asks the user to match three words with three pictures by dragging them into place. The user picks up each word and drags it to a slot beneath one of the pictures. The order of the pictures and the words are randomized in such a way that all three do not line up initially.

Scratch and See—

In the scratch and see template, the user scratches a mask off a hidden picture and then tries to guess what the picture shows. When the user opens the story interaction, a voiceover says, “Scratch away the question mark to see the picture.” The user then uses the mouse to scratch away the mask and the scratch bar is depleted based on the number of pixels the user has scratched away. The user can scratch away 30% of the total pixels in the mask. When the user has scratched to the limit, a “ding” sound effect plays, the scratch bar disappears and is replaced by answer choices. The text at the top of the frame changes to “What do you see?” and this voiceover is read out loud. The voiceover then reads each answer out loud, highlighting each as it is read. The user clicks on the answer, and appropriate feedback, as described above, is provided.

Word Bird—

Word bird is a twist on a classic hangman game. For example, the user guesses letters to reveal a hidden word in order to help a penguin fly away using a bouquet of balloons. When the user launches the game a voiceover and a pop-up say, “Figure out the secret word to help the penguin fly.” The pop-up has a “Play” button that the user clicks to start the game. On the left is a cartoon penguin holding a bouquet of ten balloons. On the right are the secret word (with as space for each hidden letter) and all the letters of the alphabet on letter tiles. To play, the user clicks on any letter of the alphabet. The letter flashes yellow for a moment of suspense and then if it is part of the hidden word, the letter tile turns green with a happy sound effect and the letter appears in the hidden phrase, possibly more than once. The penguin goes slightly higher. The penguin has a certain distance it will travel regardless of the number of correct letters. In one embodiment, the code counts the number of correct letters and divides the vertical space the penguin travels accordingly. If the letter is not part of the hidden word, the letter tile turns red, one of the balloons pops, and the penguin is animated in a state of alarm after which the penguin returns to his normal state. The game continues until the user completes the secret word or pops all of the balloons. If the user completes the phrase, it is read out loud. The penguin then is animated as flying the rest of the way off screen. Once the penguin is gone, a pop-appears that says, “Nice Flying!” and a button to “Play Again”. It user pops the last balloon, the penguin falls to the ice below. The animation shows that he is chagrinned but not hurt. The rest of the words then fade into the hidden phrase. A pop up opens stating. “Your Grounded!” with a button to “Play Again”.

Each time that the user plays again, the user gets a new problem, whether the user won or lost the round. Each book may have a certain number of hidden words, specified in the metadata for the book. These words can vary in length. In one embodiment, the words are presented cyclically, so the user plays all of the words in order and then cycles through the same words again.

Memory Match—

This is a classic concentration game, used in the e-reader as a story interaction for picture books and leveled readers. The screen is filled with face-down cards. Each turn, the user turns over two cards trying to make a match. When the user does so, those two cards remain turned over. The user continues flipping cards until the user has made all of the matches. Because the engine is used for many books, different matching criteria are used. Some books will use exact matches, but others may match first letters to words, words to pictures, etc.

Each book may use different matching criteria. Possible matching criteria are: match exact pictures, match a picture to its starting letter, match a picture to the word, match words that rhyme, and match a number to an equivalent formula (for example, 4 and 2+2).

Jigsaw Puzzles—

This is a classic jigsaw puzzle engine, in which the player places pieces to complete a picture from the book. In the e-reader, it is used as a story interaction for picture books and leveled readers. There are three puzzles for each iteration of the story interaction, using three different pictures at three different difficulty levels.

After the user chooses the puzzle, the user goes to the game interface. At first, the puzzle is in its completed form, giving the user a chance to see what the completed puzzle will look like. Text beneath the puzzle and voiceover say. “Click the puzzle to start playing.” The user clicks anywhere on the puzzle and it is disassembled, with each piece landing outside of the rectangle of the puzzle. Within the space where the user will reassemble the puzzle, the outline of each puzzle piece shape is shown. There are two ways to move a puzzle piece: drag-and-drop and click-and-stick (a first click attaches a piece to the cursor, and a second click releases it). If the user drops a piece in the correct spot, it snaps into place. If the user drops it anywhere other than the correct spot, it snaps back to its original place outside the puzzle frame. The game is over when all puzzle pieces are placed correctly.

Scramble—

Scramble presents a word or phrase taken directly from the book or related to the book and then scrambles the letters. As shown in FIG. 29, the template includes a written clue. The letters are randomly scrambled into spots each time the user plays. The user uses the mouse to pick up and drag a letter tile. The user can drop a tile in any slot and it trades places with the tile in that slot. The user continues to rearrange the letters until the user spells the word or phrase. When the user completes the word or phrase, the word or phrase is animated to indicate success (e.g., each tile pulses in tarn from the beginning to the end of the phrase) and a victory sound effect plays.

More difficult instances of Scramble may offer a clue. If a clue is offered, an additional “Give me a Clue” button appears within the scramble frame. When the user clicks this button, a number of the tiles snap automatically into their correct places and cannot be moved again. These tiles also change appearance to make clear that they can no longer be moved. Once used, the “Give me a Clue” button disappears and cannot be used again.

About You—

About You gives the user a series of questions that are used to determine something about the user. The first frame sets up what the quiz is being used to figure out. As an example, the quiz may be about which character in a story the user is most similar to. The user will be asked a series of questions about themselves. Each of the answers adds to the score of one possible outcome. A progress marker at the top of the template shows the user how many questions there are to answer and which question the user is on. After the final question is answered, the interaction tallies which outcome got the most points and delivers the appropriate message. The script for About You quiz interactions also includes a “tiebreaker” ranking, which tells the user which outcome wins if more than one ends up with the same score. In the case of a tie, whichever outcome is higher on this list is the winner.

Word Twister—

Word Twister challenges the user to make as many words as the user can out of the letters in the title of the book (or some part of the title). All of the letters from the word arrange themselves as letter tiles. The user presses the letters to spell a word. Each letter can only be used once in a word and changes state to show that it has been used. When the user believes the user has a word, the user presses the “Done” button. If it is a valid word, it gets added to the word lists. If it is not a valid word, a buzz sound effect tells the user to try again. If the user wants to start the user word over, the user can click the “Clear” button.

All of the words are stored by letter length. The user may be told the total number of possible words in each letter category, giving the user an incentive to keep looking for more and longer words.

Pop-Up Quiz—

When the user opens the pop-up quiz template, the user starts immediately on the first question. There are always four answers. An indicator along the top shows where the user is in the progression of the five questions that make up the quiz. After the user answers the fifth and final question, the user comes to the results screen. This screen tells the user how many questions out of five the user answered correctly and shows custom text based on the number that the user got correct.

Who Said It?—

This template gives the user a series of quotes from the book and asks the user to identify who said each. There are always five quotes and six names, so one of the names is a distracter. To play the user picks up each name and drops it into one of the spaces associated with the quote. Whether or not it is correct, it snaps into place. The user can also pick up a piece and drop it somewhere else. If the user drops to piece not in any slot, it snaps back to its original position at the bottom. At any time, the user can click “Check Answers”. Any name that is in the correct place turns green and that piece can no longer be moved. Any name that is not in the correct place flashes red and then snaps back to its original spot on the bottom of the screen.

Favorites and Top 10 Picks—

In another embodiment, the user may mark any book as a favorite when in the bookshelf interface. In one embodiment, a virtual pile of stickers is provided to the user. The user drags and drops these stickers onto any book, where it sticks to the cover. That book is now a favorite. To revoke favorite status, the sticker is dragged off the book and dropped back in the pile or onto any empty spot on the screen.

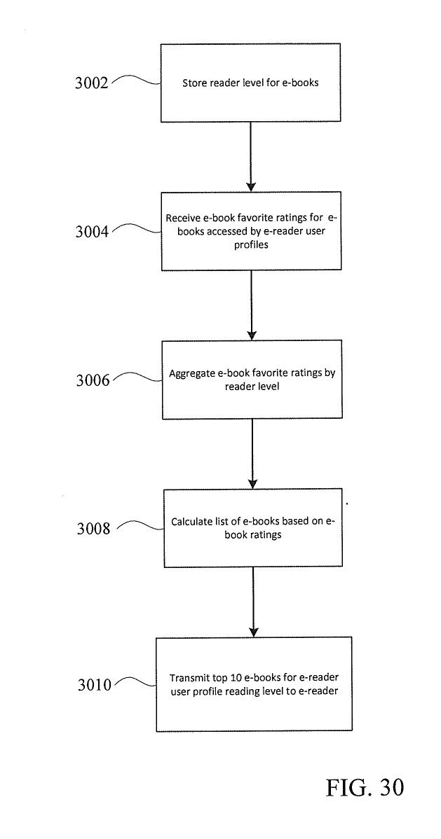

Pressing a “Top 10 Picks” button opens a pop-up window showing the list of books that have most often been designated as favorites by all of the e-reader users who use the reader. A flow diagram of this is shown in FIG. 30. As shown in block 3002, e-reader content server 112 stores the reader level for each of the e-books downloaded to the various e-readers. The users place stickers on each of their favorite books, or otherwise mark their e-books as a favorite, which is then uploaded, to e-reader content server 112 in block 3004 during synchronization.

The number of favorite ratings each e-book receives determines what books are parts of the top 10 lists. There are 4 top 10 lists, one per each book type picture books, level readers, chapter books, and young adults. Each e-book can become one of the top 10 in one of the lists based on its book type attribute. When an e-reader user marks an e-book as a favorite, that e-book receives a vote towards being one of the top 10 in its respective list. Similarly when an e-reader user un-marks an e-book as favorite, that e-book loses a vote. If a book is removed from an e-reader user bookshelf and that e-book was marked as a favorite, that e-book loses a vote. If an e-reader user profile is deleted from a user account (i.e., the entire bookshelf is deleted), then all the e-books that were marked as favorites loose a vote. If an e-book is purged from a supervisor user server bookshelf, that e-book loses one vote per each e-reader user profile under the supervisor account in which the e-book was ranked as a favorite.

Each e-reader user reader will see one of the 4 lists according to his/her age as calculated from the birth date recorded in the e-reader user profile—picture books for ages up to 6 years, level readers for ages 7 and 8, chapter books for ages 9 to 11, and young adult books for ages 12 years and older.

E-reader content server 112 will calculate the top 10 lists out of the individual user preferences as shown in block 3008. This can be done as soon as the individual user votes are received as part of the synchronization process or in batch mode scanning all user profiles periodically. The top 10 lists may be updated at least every day. E-reader content server 112 then transmits the list back to the e-readers for display to the users in block 3010.

In an alternative embodiment, the favorite ratings may be determined by the e-reader user statistical information. For example, e-reader content server 112 may aggregate total reading time for each book and calculate a top ten list of books that e-reader users have spent the most time reading. Any of the different e-reader user statistics, or a combination thereof, collected by the e-reader can be used for the favorites list. This provides an Objective evaluation of the e-books rather than a subjective view such that comes from direct user ratings.

Collectible Cards

The collectible cards engine shows a collection of two-sided cards. When the user launches the interaction, the user sees all six cards, face up. Each card has a zoom button associated with it. When a user clicks this button, the card will zoom to the foreground while the other cards disappear and the zoom-in button becomes a zoom-out button. When the user clicks the zoom-out button, the card returns to its original spot and the other cards reappear. When the user is zoomed in, the user also has a “flip” button, which triggers an animation of the card flipping over to show the back side of the card.

Each iteration of the template has unique art for the front and back of each card. There is also a unique graphic header that is part of the metadata for each book, and is not a hard-wired part of the template.

Movies, Flash Games and Graphics

Along with the above, extra content may be delivered with an e-book such as movies, flash games and graphics. Within the reader, extras are handled like story interactions, triggered from the same lightning bolt icons. Movies can appear in older or the younger e-reader user books. When the user triggers a movie extra, a pop-up appears containing the movie. At the top of the frame is a line of introductory text. This text is automatically read out loud as soon as the frame opens and can be read again by pressing the standard replay button. Flash games can appear in older or the younger e-reader user books and function almost identically to videos. The entire frame is filled by the flash file. Again, the frame must be scalable to support different game dimensions. Graphics consist of single-frame graphics that open in a pop-up window over the book pages. The content might consist of a transcribed author interview, a “did the user know” fact related to the content of the book, or a relevant piece of art (e.g., an original Clifford The Big Red Dog illustration). Any of these content types would be flattened into a single PNG file prior to incorporation into an e-book file. The size may be variable and the frame should be able to stretch to accommodate any size and aspect ratio.

Picture Starters

Picture Starter is a creativity tool that invites the user to draw a picture related to the book the user just read. The user starts with part of the picture in place (e.g., a detail, a frame, or a setting) and then completes the picture. The user also has the option to start on a blank page.

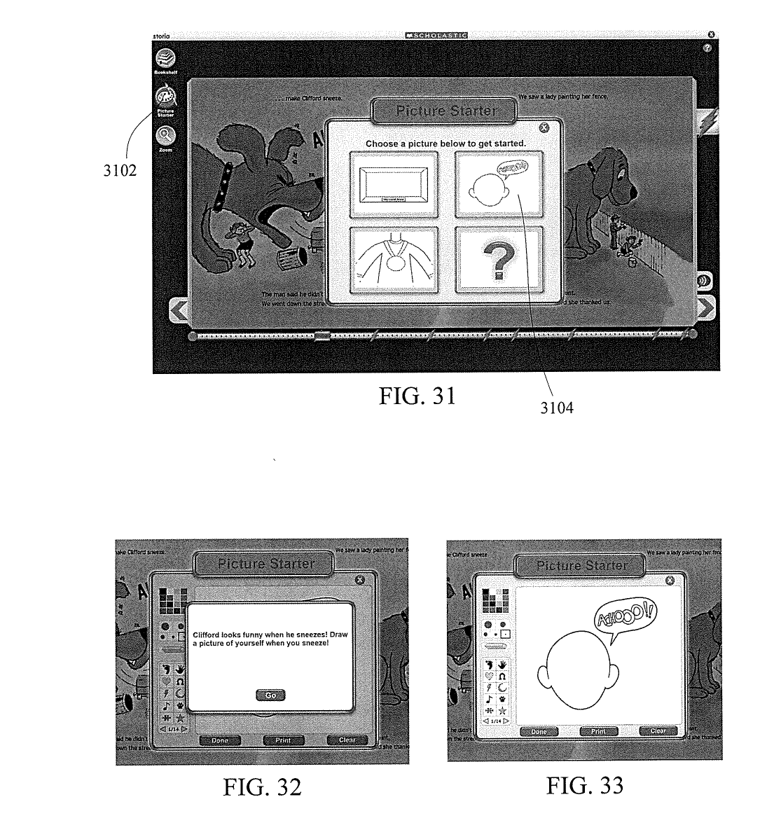

The picture starters are launched from a picture starter button 3102 as shown in FIG. 31. The picture book version may give the user three choices that are customized to every picture book. The leveled reader version gives the user one of two standard choices. There may also be a version of Picture Starter that allows the user to “sip.” the e-book. This can appear in any picture book or leveled reader and unlike the other picture starters, is triggered by a story interaction lightning bolt in the left margin.

Picture Starters for picture books begin with an introductory screen where the user picks one of several picture starters 3104, each represented by a thumbnail image and a one-word description. The user clicks on a thumbnail image and a pop-up window opens describing the picture starter. For instance, the pop-up as shown in FIG. 32 might say, “Clifford looks hinny when he sneezes! Draw a picture of yourself when you sneeze.” This text is also read out loud. The pop-up window has a “Go” button, which when pressed, closes the window and starts the drawing interface.

The drawing interface may be divided into a large drawing area and a tool panel as shown in FIG. 33. The drawing area starts with some simple art intended to give structure and inspiration for the picture, the outline of a face in this example. There may be various drawing tools such as paintbrushes with selection of colors and point sizes, a set of stickers, an eraser or any number of well-known drawing tools. The picture may be printed, cleared or the user may exit from the picture starter.

Leveled readers do not have any custom images or picture suggestions. Instead, the user is provided with one of two standard prompts and then presents the user with a blank canvas. For example, two prompts are: “Draw your favorite part of this book” and “draw a new ending to this book.”

Inscriptions use the picture starter engine to allow the user to “sign” the e-book. It is only used for certain picture books and leveled readers and has a background graphic customized for the book. Unlike the other versions of picture starter, this one is launched from a lightning bolt on the first page of the book and is housed in a story interaction style frame. Once launched, inscriptions skip the introduction screen and skip directly to the drawing interface. The pop-up says, in text and voiceover, “Write your name to make this book your own!” The user closes this pop-up to start drawing.

Friends and Reading Groups

The e-reader may also have functionality around social networking. This functionality, in one embodiment may be accessed through a “Friends & Reading Groups” icon on the home page of the e-reader. The “Friends and Reading Groups” area is only available if the user is online. If the user is offline and presses the button from the bookshelf, the user will receive a note telling the user that the user must be connected to the Internet in order to use these features.

When the user visits “Friends and Reading Groups” for the first time, the user may be asked to choose an avatar picture to represent themselves. These pictures will be created based on e-reader user's passion topics and interests (e.g., dinosaur or galaxy) or hobbies (e.g., a baseball bat or saxophone). Images may be created for e-reader users to choose from, divided into easily accessed categories. The user may choose an image either by scrolling through the list, or by using the “Show Pictures With” drop down menu located at the top of the page. This drop down menu allows the user to show pictures in a certain category or about a certain topic (e.g., “animals”, “Word Girl”, “sports”, etc.). This is the image that the friends see when they add the user to their friends list. The user can change the avatar image at any time simply by clicking on the image itself, which returns the user to the selection interface.

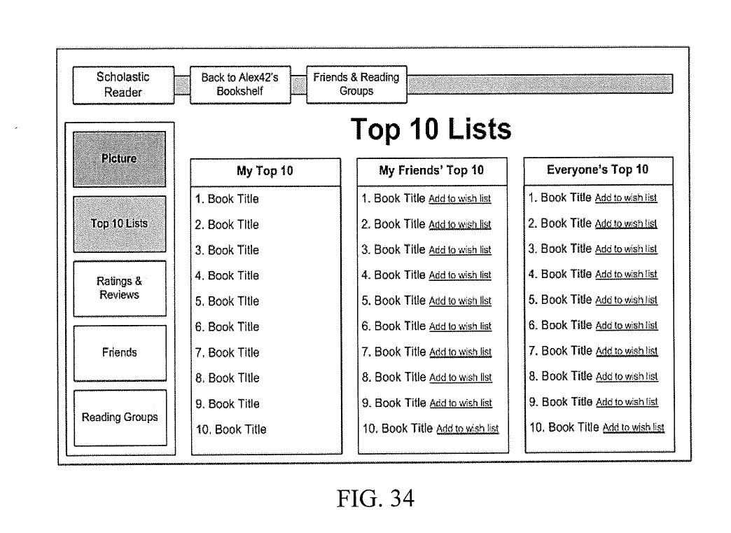

The Top Ten list enables the user to set the top ten books and to view the Top Ten books of other users of the e-reader. An example of the screen is shown in FIG. 34. There may be three top ten lists:

My Top 10—This is where the user sets their own list of the top ten books that the user has read. The first time that the user comes to the screen, none of these books are specified. Instead, each line of the list is a pull down menu that includes all of the books on the bookshelf. The user may use this menu to specify the book the user wants in each position in the Top 10. If the user selects a book that is already in another slot, that slot goes back to being unassigned, so that the user does not have the same book in multiple slots. As soon as a book is selected, the choice is saved. If the user navigates away from the page and back again, the book name is still in its saved slot. There is also a button to reopen the pull down menu at any time and choose a new book for any slot.

My Friends' Top 10—This list appears only if the user has added at least one friend. This combines all of the friends top ten lists with their own into a single list. The list is created according to a numerical formula: Every “1” ranking for a book is worth ten points; every “2” ranking is worth nine points, and so on. These values are tallied together and the list is created based on the totals.

Everyone's Top 10—This list combines the top 10 lists of all the e-reader users who use the e-reader, using the same formula as described above. This list is filtered, however, so that the user only see books appropriate to their age,—e.g., the list would not show any picture books for a ten year old.

This Top 10 feature is designed to give e-reader users ideas for books they may want to read. Next to each book is an “Add to wish list” link, which connects with e-commerce website server 114 to add the book to a wish list that the supervisors can read. This design may include cover thumbnails as well as book titles to give the books more appeal.

Ratings and Reviews—The Ratings and Review page is where the user can quickly view e-books on the bookshelf, set and view the ratings for the e-books, and write, read, or edit any reviews that the user has written for the e-books.

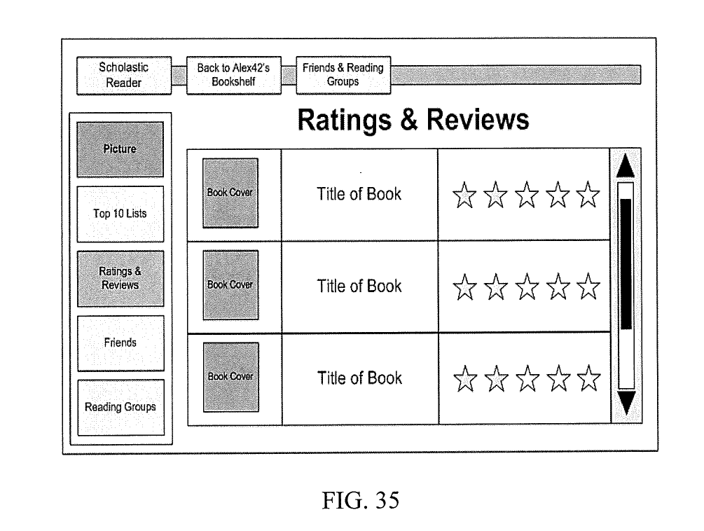

All of the e-books are shown as a scrollable list, with the image of the book cover on the left, the title of the book next to the cover and the image of five stars along the right side as shown in FIG. 35. The user can set the rating by clicking on these stars next to the title, with five stars being the highest and one star being the lowest. The user can also rate a book while the user is reading the e-book and changes made in either place show up in both. The ratings are saved immediately so that if the user navigates away from the screen and back again, the user's choices will not be lost.

The user can also roll over the title of the book to see a short blurb from a written review of the book. This review could have been written in the reading mode or written on the Ratings and Review page and saved during an earlier session. When the title is rolled over, the beginning of the review appears in a small pop-up.

Any changes the user makes to the review (either by writing a brand new review or editing the existing text) are automatically saved, and are remembered if the user navigates away from the page and back again.

Ratings are set on the e-reader user profile bookshelf screen. A book may be rated within the hover that appears when the user hovers over a book. Before the user rates any book, the stars next to “My Rating” all show as empty and the “All e-reader user profile” rating is not shown. The user may click on any star to set the rating. For instance, to give a book a 4-star rating, the user clicks on the fourth star.

At the moment that the user sets a rating, the “All e-reader user profile” rating also appears. Unlike “My Rating”, the “All e-reader user profile” rating is able to show half-stars and the aggregate rating is rounded to the nearest half-star. Ratings are also listed in supervisor tools.

Friends—

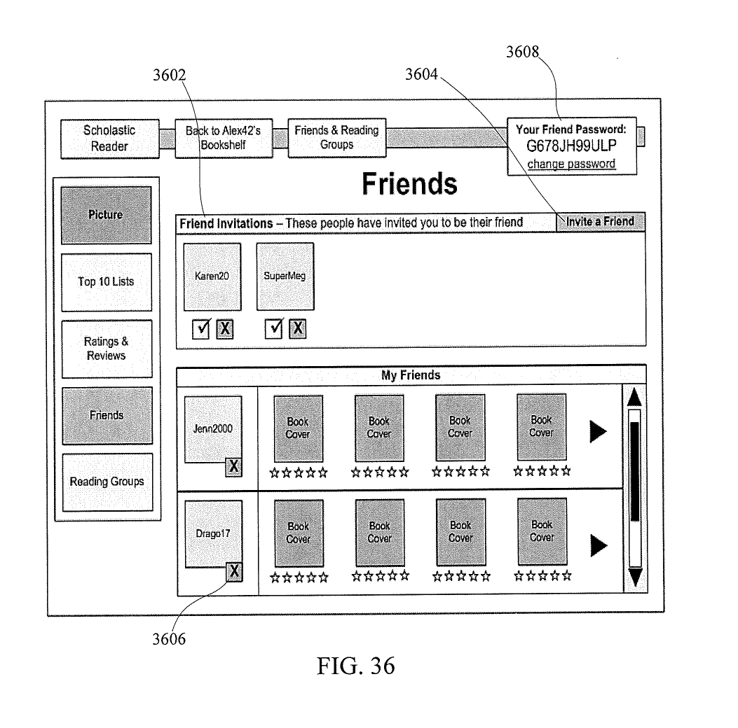

The Friends area is designed for e-reader users to reach out to friends who also use the e-reader and share book interests. On the Friends page as shown in FIG. 36, the user can invite someone to be a friend, accept a friend invitation, or view their friends' book lists, ratings and reviews.

The user friend password 3608 is a unique, randomly generated string that another user needs to invite the user as a friend. It should be sufficiently complicated that the chances of guessing one at random are negligible. The only way to find out someone else's Friend Password is to ask them offline. The user's friend password is posted on the Friends page. The text can be highlighted and copied to make it easier to e-mail. The user can reset the Friend Password at any time by pressing the Change Password button. This creates a new, randomly generated password and disables the old one.

To invite a new friend, the user clicks on the Invite a Friend button 3604. A pop-up opens asking the user to enter their Friend Password. Once the user does this, an invitation appears on the invitees' Friends and Reading Groups screen, which they will see the next time they come to the page.

All of the pending friend invitations are shown on the Friends page under Friend Invitations 3602—these are all people who have invited the user to be their friend as described above. Their avatar pictures and usernames are shown with buttons to accept or decline each invitation. If the user accepts the invitation, that person becomes a friend. If the user declines, the user is asked to confirm this decision, and then the invitation is removed. There is no “second chance” to accept an invitation unless that person invites the user again.

Friends that have accepted the invitation or friends that the user has accepted are added to the Friends list. This is a scrollable list on the Friends page that features the friends' names and pictures, books on their bookshelves, and their ratings and reviews. Along the left side are their pictures and names, and to the right a list of all of their books. The user can scroll left to right through their lists, and underneath each book view the rating, if any, that they have given the book.

The user can also roll over the title of the book to see their friend's written review. When the user rolls over the title, their review appears in a small pop-up window, which is automatically sized to the length of the review text. If it is a short review the pop-up is smaller, if it is a lengthy review a larger pop-up appears. If the friend did not write a review, the pop-up window does not appear at all.

The user can remove a friend at any time by clicking on the X button 3606 located underneath the friend's name. If the user clicks on the X button 3606, a pop-up window appears asking the use to confirm that the user would like to remove this friend. Once removed the friend disappears from the list and cannot be added back unless the user sends or receives another invitation from that friend.

Reading Groups—

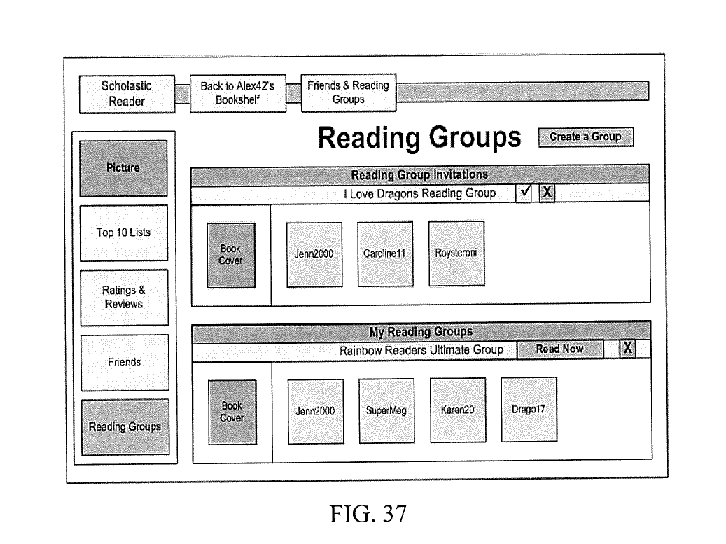

On the Reading Groups screen as shown in FIG. 37, the user can set up reading groups with anyone in the Friends list. The screen includes the status of the reading invitations and enables the user to accept or decline any invitations that have been sent to the user. The user can also view the existing reading groups and launch a book in a “shared reading” mode.

If the user has a Reading Group invitation from a friend, an alert appears on the Reading Group tab in the navigation bar on the left side of the screen. This lets the user know immediately that an invitation is pending, so that the user can go directly to the Reading Groups screen. On that screen, the invitation is posted in the “Reading Groups Invitations” section. The user will see the name of the reading group (e.g., “I Love Dragons Reading Group” as shown in FIG. 37), the cover of the book the user is reading, and the pictures and usernames of the other members of the group. In one embodiment, the creator of the group is always on the left and their picture is highlighted in some way.

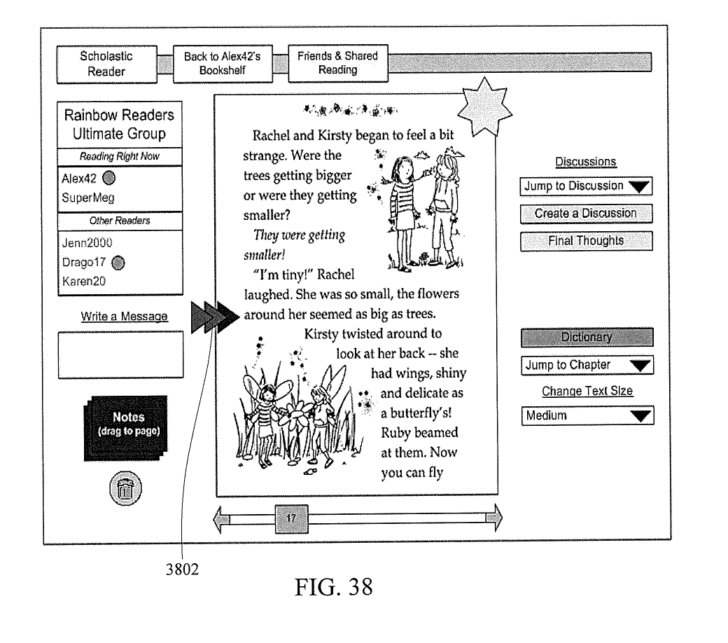

The user has two buttons, a checkmark and an X, that the user employs to accept or decline the reading group. If the user clicks the X to remove the reading group, the user is asked to confirm the selection, and then the invitation is removed. If the user clicks the checkmark to accept the reading group, the reading group is added to the screen in the “My Reading Groups” section, (e.g. the “Rainbow Readers Ultimate Group” as shown in FIG. 38).

To join a reading group, the user first must own the book selected for the group. If the user does not own the book, the user will receive a pop-up window suggesting that the user purchase the book and providing the user with the option to add it to the user's wish list. To start a reading group, a user can click on the Create a Reading Group button. The user is asked to specify the following:

A name—This is the name of the reading group and can be anything the user wants to distinguish its reading groups from other reading groups. Simply type the name of the group in the available field (e.g. “Outer Space is Awesome Group”).

The book—Each reading group is focused on a specific book. Books can only be selected from the bookshelf and are chosen from a pre-populated list.

The members—The members of the reading group are selected from people who are already in the accepted friends list, up to five total people. As part of the interface for adding friends to a reading group, those friends who already own the book being read are visually differentiated. The user can add friends who do not own the book, but they will have to purchase the book before accepting the invitation.

When the invitation is sent, the group name and avatar pictures of the friends in the group appear at the top of the “My Reading Groups” list. The word “waiting” is shown under each friend's picture until the invitation is either accepted or declined by them. Friends who decline are simply removed from the group.

Removing a Group—To remove a reading group from the list, a user can click the “X” button for that reading group. This removes the group from the list, but does not destroy the group. The remaining members are still able to participate without the user. A group is only destroyed if every member chooses to remove it.

Shared Reading—

To start reading a book in “Shared Reading” mode, a user can click the “Read Now” button for a reading group and the shared book will launch. Although this interface is similar to the general reading interface, it is actually a separate version of the book and updates in this mode are not seen in the version of the book that is on the bookshelf, or vice versa.

When the shared reading is started, the interface appears as shown in FIG. 38. A number of standard reading interface features are not available. These features that are not available include setting bookmarks, jumping, to bookmarks, rate and review, highlighters and story interactions. There are, however, a number anew features unique to this mode and designed specifically for the share reading experience. These features are described below.

Group Status—The box in the upper left corner of the screen shows the name of the group and all of the members, sorted into those that who are reading at this moment and those who are not. Each person's User ID in this box is a unique color, and this color is assigned to them throughout the shared reading experience, including all comments and notes.

Status Messages—Each member of the group has the option to post a single status message. This is intended for short blurbs and updates like, “Everybody turn to chapter 6” or “Going to get a snack. Be right back” Members that have a current status message have an icon next to their names and this icon appears differently depending on whether the user has read the message. To read another member's message, roll over this icon and the message appears in a pop-up window.

To enter a message, the user types the message into the “Write a Message” box and presses enter. The user can only have one message a time, so if the user writes a new message, it deletes the old one. A message is saved until the author of the message chooses to delete it. A user can delete a message by clicking on the message icon next to the name.

Using Notes—Notes are added as in the general reading interface, except that the notes are shared with everyone in the group. To make this work, each member of the group has his or her own note color, which matches the color of the name in the Group Status box. Members who would like to respond to the note can add a note of their own, which appears on top of the note, with the more recent notes stacking on top. In FIG. 38, Alex42, Drago 17 and SuperMeg all added notes on the same line of the book. To read the notes, the user clicks on the triangle 3802 representing the note the user wants to read.

To delete one of the notes, the user drags the note to the trash can located on the left side, just like in the general reading interface. The use cannot delete notes that are not their own.

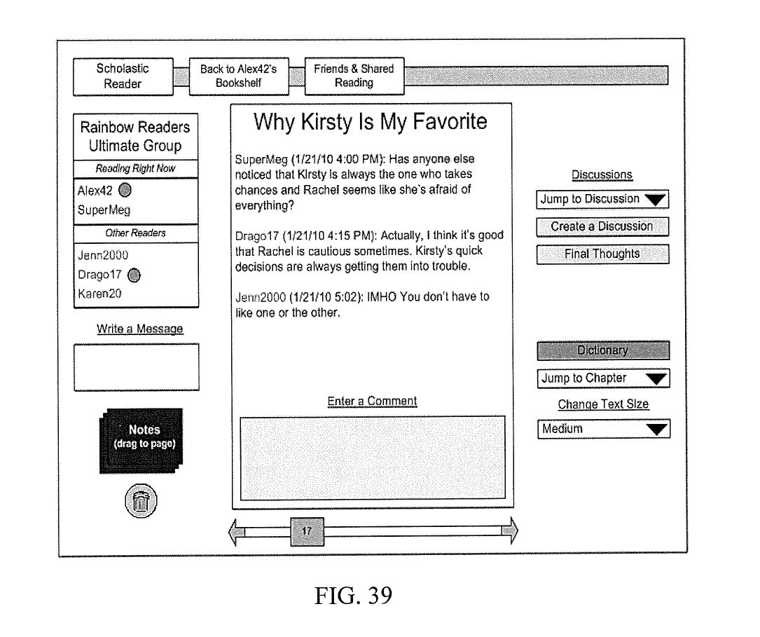

Discussions—A discussion is like a message thread that can be started at any page in the book. Any member can start a discussion by pressing the “Create a Discussion” button. The user is asked to enter a title for the discussion and an initial comment. The discussion then gets pinned to the page the user is on, shown as a graphic In the upper right corner of the page (such as, a star as shown in FIG. 38). Any other member who comes to the page can then click on this icon to open the discussion. A sample of the discussion is shown in FIG. 39.

Any member can respond using the field located at the bottom of the discussion area. When the user types a comment and presses Enter, the text the user wrote is automatically posted to the page and tagged with the date, time, name of the author, and the color assigned to that person, so people know who wrote it and when. The user can write on the page as long or short of a response as the user chooses, and as frequently as the user likes. If there are more responses than can be viewed on a single page, the list becomes scrollable. Posts appear in a linear fashion, with the initial comment on top and subsequent comments appearing down the page in the order that they were entered. There is also a close button (not shown) that closes the discussion and returns the user to the book on the page the user was on.

Jump to Discussion—The “Jump to Discussion” pull down menu allows the user to jump to any discussion in the book, listed by page number and the title of the discussion as specified by the member who started it. For example, the discussion in FIG. 39 is listed as “P.17—Why Kirsty is My Favorite”. Discussions that have been updated since the last time the user looked at them are visually distinguished, so that the user can quickly find new parts of the discussion.

Final Thoughts—The Final Thoughts page is special discussion that appears by default at the end of every book, and is intended as a place for members to post their final review or thoughts about the book. Other than the fact that it is automatically generated rather than user-created, the Final Thoughts page functions like any other discussion. There is a button on the screen to jump to the Final Thoughts screen at any time.

Read Another Book with This Group—On the Final Thoughts page of the book, the croup leader also has a button that allows him to “Read Another Book with this Group”. This is essentially a shortcut that allows the user to form another reading group using the same members as the current group, changing only the book that the group is reading. This is especially helpful if the group is moving on to another book in the same series.

Updates in Shared Reading Mode—All updates made in Shared Reading mode must be stored on the server and propagated to others in the group as soon as they are made. That means that as soon as the user closes a note, it is visible to others in the group, or as soon as the user updates a discussion, the changes are visible to everyone.

In an alternative embodiment, the e-reader will include the ability for multiple parent users to access their accounts on a single computer. This means that a supervisor will be able to “log out” and another supervisor to “log in”.

Potentially, the e-reader will include sophisticated reporting that allows the system to track more closely each event that occurs within a reading session. For instance, the e-reader can record on a per-session basis how many times an e-reader user accesses story interactions, how many books they read, how many pages they turn, etc.

E-reader content server 112 or the e-commerce website may add animations within the pages of an e-book. Animations can be triggered either by clicking a specific hotspot, automatically upon turning to a page, or as a reward for a correct answer to a “Touch the Page” interaction. The placement and behavior of animations is specified by clearly formatted XML that is included within the e-book file, similar to story interactions. The animations themselves may be delivered in a graphic format. Animations can include custom sound effects, also specified within the XML.

Branching Storylines

Branching stories are books, written in the second person, in which the user makes decisions as part of the reading experience—for example, choosing between two possible courses of action or naming something within the story. These dynamic books are able to utilize the reader's choices to impact and inform the story text, action and plot development. The user is able to choose between multiple courses of action and be directed to different outcomes accordingly. For instance, the user might encounter a villain and be given the choice to fight or run. Each of these choices leads to an entirely different story path.

The user can name things within the story by filling in a text field. The name is assigned to a variable, where the variable appears within the story at several locations. For instance, the user might adopt a stray dog and give it a name. The variable is set to the name selected by the user. Then, each time that the dog is referred to for the remainder of the story, the given name is used.

Any choice that the user makes can set a variable that is used later. For instance, the user might be leaving on a trip and be given the choice to pack either a phone or a camera. This choice does not have any immediate consequence, but it is remembered and can impact the story later. In this example, if the user chooses the camera then the user may be given the option later in the story to take a picture of a crime in progress. If the user chooses the phone, a different choice may be available to the user.

The story begins with a setup screen in which the user defines the character. On this screen, the user can specify characteristics using text fields (e.g., the name), radio buttons (e.g., the gender), or pull down menus (e.g., the thing that scares the user most). All of these choices are stored as variables and can be used to vary the story later. Any piece of text within the story can be set based on any stored variable. For instance, early in the story the user might make a decision that causes another character to be hostile toward the user. This character's dialogue becomes different than what it would have been had the user not made that choice.

The engine may support random events, meaning that the outcome of a choice is chosen randomly. For instance, the user may shoot an arrow at a target where there is a 40% chance the user hits the target and a 60% chance the user misses the target. The outcome is determined randomly each time that the user makes this choice. The percentage of each outcome is specified within the XML and any number of possible outcomes are allowed.

Images and videos can be included anywhere within the story and will appear to be embedded within the flow of the text. These images and videos can also be varied based upon any stored variables.

Decisions can be made by choosing among pictures rather than text options. For instance, the user might see illustrations of three sets of footprints and click on the one the user wants to follow. Decisions can be made by choosing among audio files rather than text options. For instance the user might listen to three distinct animal calls and then decide which one to walk towards. In this case, the user would need two buttons associated with each sound: one to hear the sound and one to choose the sound. Page numbers within the story paginate on the fly. In other words, although the user may choose any path through the story, the page numbers will be generated automatically and so will always count up in order.

Although other modifications and changes may be suggested by those skilled in the art, it is the intention of the inventors to embody within the patent warranted hereon all changes and modifications that reasonably and properly come within the scope of their contribution to the art.

We claim:

1. An e-reader comprising;
a memory for storing electronic published content and information relating to an e-reader account;
a display for rendering the electronic published content into a visual form;
a user input device; and
a processor coupled to the memory, display and user input device that is operative to enable actions for:
verifying administrative access by a supervisor user associated with the e-reader account;
displaying a representation of electronic published content and a prompt for assigning the electronic published content to one or more e-reader user profiles;
associating the electronic published content with an e-reader user profile;
displaying a representation of the electronic published content to the e-reader user profile only while the electronic published content is associated with the e-reader user profile; and
enabling access by a user of the e-reader profile to the electronic published content only while the electronic published content is associated, with the e-reader user profile.

2. The e-reader of claim 1, wherein the prompt for assigning the electronic published content includes two or more e-reader user profiles associated with two or more e-reader users.

3. The e-reader of claim 2 wherein each of the two e-reader user profiles contains personalized information identifying the e-reader users consisting of a name chosen by or for each of the e-reader users.

4. The e-reader of claim 1 wherein the user input device is one of a mouse, keyboard, touch screen or e-reader navigation button.

5. The e-reader of claim 1 wherein the electronic published content is an e-book.

6. The e-reader of claim 1 wherein the representation of the electronic published content may be ordered by date downloaded, date published, alphabetical by title or author or by a user of the e-reader profile dragging and dropping the representation or the electronic published content.

7. The e-reader of claim 1, wherein the processor is further operative to enable actions for:
communicating with a remote server; and
receiving the verification of administrative access by the remote server.

8. The e-reader of claim 1 wherein the e-reader user profile contains personalized information identifying the user consisting of a name chosen by or for the user.

9. The e-reader of claim 1 wherein the representation of the electronic published content is by displaying front covers of the electronic published content on a simulated bookshelf.

10. A system for communicating over a network, comprising:
a plurality of e-readers, wherein each e-reader is configured to transmit and receive messages over the network;
a network device in communication with the plurality of e-readers, and
one or more of the e-readers in combination with the network device is configurable to perform actions, including:
verifying a username and password associated with a supervisor user for an e-reader account;
enabling the supervisor user to assign or de-assign electronic published content to one or more e-reader users only after verification of the supervisor user name and password;
enabling access by the e-reader use to the electronic published content only while the electronic published content is assigned to the e-reader user.

11. The system of claim 10, wherein one or more of the e-readers in combination with the network device is configurable to perform further actions, including:
storing e-reader device settings; and
communicating the e-reader device settings to another instance of the e-reader device for the same e-reader account.

12. The system of claim 10 wherein electronic published content may be assigned or de-assigned to a second e-reader user associated with the e-reader account only after verification of the supervisor username and password.

13. The system of claim 10 wherein the e-reader users includes the supervisor as an e-reader user.

14. The system of claim 10 wherein the e-reader users include the supervisor and a second e-reader user.

15. The system of claim 10 wherein the list of e-reader users includes two or more e-reader users that are not the supervisor user.

16. The system of claim 10, wherein one or more of the e-readers in combination with the network device is configurable to perform further actions, including:
displaying to each e-reader user only electronic published content that is currently assigned to the respective e-reader user.

17. The system of claim 16 wherein the electronic published content is displayed to each e-reader user on a page separate from electronic published content displayed to other e-reader users, and which page is accessed through use of personalized information associated with the e-reader user.

18. A method of managing an e-reader account comprising:
verifying a username and password associated with a supervisor user for an e-reader account;
generating at least one e-reader user profile associated with the e-reader account only after verification of the supervisor username and password;
enabling election of assignment or de-assignment of electronic published content with the at least one e-reader user profile only after verification of the supervisor username and password;
displaying on a display of an e-reader a representation of the electronic published content assigned to the e-reader user profile only on assignment of the electronic published content to the at least one e-reader user profile; and
enabling access through the e-reader by the e-reader user to the electronic published content only while the electronic published content remains assigned to the e-reader user profile.

19. The method of claim 18 wherein there are at least two e-reader user profiles associated with the e-reader account, each e-reader user profile identified by personalized information.

20. The method of claim 19 wherein the electronic published content is an e-book.
